(19) United States
(12) Patent Application Publication
(10) Pub. No.: US 2024/0083455 A1
(43) Pub. Date: Mar. 14, 2024

(54) FUNCTION CONTROL DEVICE, FUNCTION CONTROL PROGRAM, AUTOMATED DRIVING CONTROL DEVICE, AND STORAGE MEDIUM

(71) Applicant: DENSO CORPORATION, Kariya-City (JP)

(72) Inventors: Takuya KUME, Kariya-City (JP); Kazuki IZUMI, Kariya-City (JP)

(21) Appl. No.: 18/510,634

(22) Filed: Nov. 15, 2023

Related U.S. Application Data
(63) Continuation of application No. PCT/JP22/18845, filed on Apr. 26, 2022.

(30) Foreign Application Priority Data
May 27, 2021 (JP) 2021-089554
Nov. 12, 2021 (JP) 2021-185011

(51) Int. Cl. B60W 60/00

(52) U.S. Cl. CPC B60W 60/001; B60W 2540/00; B60W 2554/406; B60W 2554/802; B60W 2754/30

(57) ABSTRACT

A function control device that is used in a subject vehicle capable of traveling by an automated driving function and performs a control related to the automated driving function is configured to grasp an abnormal state of a physical condition caused in a driver of the subject vehicle, and grasp a travel control mode in which the automated driving function is in operation, the travel control mode being included in a plurality of traveling control modes included in autonomous travel control without obligation for the driver to monitor surroundings.

### CROSS REFERENCE TO RELATED APPLICATION

The present application is a continuation application of International Patent Application No. PCT/JP2022/018845 filed on Apr. 26, 2022 which designated the U.S. and claims the benefit of priority from Japanese Patent Application No. 2021-089554 filed on May 27, 2021 and Japanese Patent Application No. 2021-185011 filed on Nov. 12, 2021. The entire disclosures of all of the above applications are incorporated herein by reference.

### TECHNICAL FIELD

The disclosure herein relates to a function control device, a function control program, an automated driving control device, and an automated driving control program, which are related to an automated driving function.

### BACKGROUND

A related art describes a control device that enables automated driving without obligation for a driver to monitor surroundings by performing all driving operations.

### SUMMARY

According to one example, a function control device that is used in a subject vehicle capable of traveling by an automated driving function and performs a control related to the automated driving function may be configured to grasp an abnormal state of a physical condition caused in a driver of the subject vehicle, and grasp a travel control mode in which the automated driving function is in operation, the travel control mode being included in a plurality of traveling control modes included in autonomous travel control without obligation for the driver to monitor surroundings.

### BRIEF DESCRIPTION OF DRAWINGS

FIG. 1 is a diagram illustrating an overall image of an in-vehicle network including an automated driving ECU according to a first embodiment of the present disclosure.

FIG. 2 is a block diagram illustrating details of an automated driving ECU.

FIG. 3 is a block diagram illustrating details of an HCU.

FIG. 4 is a flowchart illustrating details of driving control switching processing.

FIG. 5 is a flowchart illustrating details of inter-vehicle spacing setting processing.

FIG. 6 is a diagram illustrating details of MRM control in a traffic congestion scene 1.

FIG. 7 is a diagram illustrating details of MRM control in a traffic congestion scene 2.

FIG. 8 is a diagram illustrating details of MRM control in a traffic congestion scene 3.

FIG. 9 is a flowchart illustrating details of MRM transition processing.

FIG. 10 is a flowchart illustrating details of determination switching processing performed by a deadman determination section of a third embodiment.

FIG. 11 is a flowchart illustrating details of state determination processing performed with obligation for a driver to grip a steering wheel.

FIG. 12 is a flowchart illustrating details of state determination processing performed without obligation for a driver to grip a steering wheel.

FIG. 13 is a flowchart illustrating details of transition preparation processing.

### DETAILED DESCRIPTION

When a driver or the like causes abnormality in which automated driving is less likely to continue, the control device in a related art performs vehicle control to stop a subject vehicle at an evacuation place such as a road shoulder or a parking area as a stop event, for example.

The stop event based on an occurrence of an abnormal state as in a related art causes a passenger of the subject vehicle to be likely to feel anxious. However, the control device of the related art does not perform processing for reducing uneasiness of the driver when the driver is in an abnormal state. Thus, the passenger is likely to be uneasy about vehicle control such as the stop event.

The present disclosure provides a function control device, a function control program, an automated driving control device, and an automated driving control program, which are each capable of reducing anxiety of a passenger when a driver is brought into an abnormal state.

According to one aspect of the present disclosure, a function control device that is used in a subject vehicle capable of traveling by an automated driving function and performs a control related to the automated driving function is provided. The function control device comprises: a physical condition abnormality grasping section that is configured to grasp an abnormal state of a physical condition caused in a driver of the subject vehicle; a control state grasping section that is configured to grasp a travel control mode in which the automated driving function is in operation, the travel control mode being included in a plurality of traveling control modes included in autonomous travel control without obligation for the driver to monitor surroundings; and a control content change section that is configured to change contents of at least one of vehicle control of the subject vehicle and information presentation control for the driver according to the travel control mode in which the automated driving function is in operation when the abnormal state is grasped during a period in which the subject vehicle travels under the autonomous travel control.

According to another aspect of the present disclosure, a non-transitory computer readable storage medium storing a function control program that is used in a subject vehicle capable of traveling by an automated driving function and performs a control related to the automated driving function is provided. The function control program causing at least one processor to perform processing includes the steps of: grasping an abnormal state of a physical condition caused in a driver of the subject vehicle; grasping a travel control mode in which the automated driving function is in operation, the travel control mode being included in a plurality of traveling control modes included in autonomous travel control without obligation for the driver to monitor surroundings; and changing contents of at least one of vehicle control of the subject vehicle and information presentation control for the driver according to the travel control mode in which the automated driving function is in operation when the abnormal state is grasped during a period in which the subject vehicle travels under the autonomous travel control.

These aspects change contents of the vehicle control or information presentation control when the abnormal state is grasped in a period in which the subject vehicle travels under the autonomous travel control without obligation to monitor the surroundings according to a travel control mode in operation. Thus, the vehicle control or the information presentation control can be adjusted to contents suitable for a situation in which the subject vehicle travels. As a result, anxiety of a passenger can be alleviated when a driver is brought into an abnormal state.

According to another aspect of the present disclosure, a function control device that is used in a subject vehicle capable of traveling by an automated driving function and performs a control related to the automated driving function is provided. The function control device comprises: a physical condition abnormality grasping section that is configured to grasp an abnormal state of a physical condition caused in a driver of the subject vehicle; a control state grasping section that is configured to grasp whether driving assistance control with obligation for the driver to monitor surroundings or autonomous travel control without obligation for the driver to monitor the surroundings is in operation in the automated driving function; and a control content change section that is configured to change at least one of contents of vehicle control of the subject vehicle and information presentation control for the driver between when the abnormal state is grasped in the driving assistance control in operation and when the abnormal state is grasped in the autonomous travel control in operation.

According to another aspect of the present disclosure, a non-transitory computer readable storage medium storing a function control program that is used in a subject vehicle capable of traveling by an automated driving function and performs a control related to the automated driving function is provided. The function control program causing at least one processor to perform processing includes the steps of: grasping an abnormal state of a physical condition caused in a driver of the subject vehicle; grasping whether driving assistance control with obligation for the driver to monitor surroundings or autonomous travel control without obligation for the driver to monitor the surroundings is in operation in the automated driving function; and changing at least one of contents of vehicle control of the subject vehicle and information presentation control for the driver between when the abnormal state is grasped in the driving assistance control in operation and when the abnormal state is grasped in the autonomous travel control in operation.

These aspects change contents of at least one of the vehicle control and the information presentation control between when an abnormal state is grasped in the driving assistance control in operation and when the abnormal state is grasped in the autonomous travel control in operation. Thus, the vehicle control or the information presentation control can be adjusted to contents suitable for a situation in which the subject vehicle travels. As a result, anxiety of a passenger can be alleviated when a driver is brought into an abnormal state.

According to another aspect of the present disclosure, an automated driving control device that enables traveling of a subject vehicle by an automated driving function is provided. The automated driving control device comprises: a physical condition abnormality grasping section that is configured to grasp an abnormal state of physical condition caused in a driver of the subject vehicle; a control state grasping section that is configured to grasp whether driving assistance control with obligation for the driver to monitor surroundings or autonomous travel control without obligation for the driver to monitor the surroundings is in operation in the automated driving function; an evacuation control section that is configured to perform automated evacuation control for stopping the subject vehicle at an evacuation place when the abnormal state is grasped; and a control content change section that is configured to cause setting of an inter-vehicle distance to a preceding vehicle in the autonomous travel control to be wider than setting of the inter-vehicle distance in the driving assistance control. The control content change section causes setting of the inter-vehicle distance when the abnormal state is grasped to be wider than the setting of the inter-vehicle distance in the autonomous travel control before the automated evacuation control by the evacuation control section is started.

According to another aspect of the present disclosure, a non-transitory computer readable storage medium storing an automated driving control program that enables traveling of a subject vehicle by an automated driving function is provided. The automated driving control program causing at least one processor to perform processing includes the steps of: grasping an abnormal state of a physical condition caused in a driver of the subject vehicle; grasping whether driving assistance control with obligation for the driver to monitor surroundings or autonomous travel control without obligation for the driver to monitor the surroundings is in operation in the automated driving function; performing automated evacuation control for stopping the subject vehicle at an evacuation place when the abnormal state is grasped; causing setting of an inter-vehicle distance to a preceding vehicle in the autonomous travel control to be wider than setting of the inter-vehicle distance in the driving assistance control; and causing setting of the inter-vehicle distance when the abnormal state is grasped to be wider than setting of the inter-vehicle distance in the autonomous travel control before the automated evacuation control by the evacuation control section is started.

These aspects cause setting of an inter-vehicle distance when an abnormal state is grasped to be wider than setting of an inter-vehicle distance in each of the autonomous travel control and the driving assistance control. Thus, after the abnormal state is grasped, the inter-vehicle distance to the preceding vehicle gradually increases. The increase in the inter-vehicle distance as described above enables alleviating anxiety of the passenger even when the driver is brought into an abnormal state.

According to another aspect of the present disclosure, an automated driving control device that enables traveling of a subject vehicle by an automated driving function is provided. The automated driving control device comprises: a physical condition abnormality grasping section that grasps an abnormal state of physical condition caused in a driver of the subject vehicle; a travel control section that controls traveling of the subject vehicle under traffic congestion limited control that is autonomous travel control without obligation for the driver to monitor surroundings and is performed only in traffic congestion; and a lane grasping section that grasps a subject vehicle lane on which the subject vehicle travels when the subject vehicle travels on a road including a plurality of lanes under the traffic congestion limited control. The travel control section is configured to perform automated evacuation control of stopping the subject vehicle at an evacuation place when the abnormal state is grasped in the congestion limitation control in operation and to change contents of the automated evacuation control according to a position of the subject vehicle lane on the road.

According to another aspect of the present disclosure, a non-transitory computer readable storage medium storing an automated driving control program that enables traveling of a subject vehicle by an automated driving function is provided. The automated driving control program causing at least one processor to perform processing includes the steps of: grasping an abnormal state of physical condition caused in a driver of the subject vehicle; controlling traveling of the subject vehicle under traffic congestion limited control that is autonomous travel control without obligation for the driver to monitor surroundings and is performed only in traffic congestion; grasping a subject vehicle lane on which the subject vehicle travels when the subject vehicle travels on a road including a plurality of lanes under the traffic congestion limited control; and performing automated evacuation control of stopping the subject vehicle at an evacuation place when the abnormal state is grasped in the congestion limitation control in operation and changing contents of the automated evacuation control according to a position of the subject vehicle lane on the road.

These aspects change contents of the automated evacuation control, when an abnormal state is grasped while traffic congestion limited control is performed, depending on a position of a subject vehicle lane in which the subject vehicle travels on the road. Thus, the automated evacuation control can be adjusted to contents suitable for a surrounding situation that differs depending on the position of the subject vehicle lane. As a result, anxiety of a passenger can be alleviated when a driver is brought into an abnormal state.

According to another aspect of the present disclosure, an automated driving control device that enables traveling of a subject vehicle by an automated driving function is provided. The automated driving control device comprises: a physical condition abnormality grasping section that is configured to grasp an abnormal state of physical condition caused in a driver of the subject vehicle; a control state grasping section that is configured to grasp whether driving assistance control with obligation for the driver to monitor surroundings, or traffic congestion limited control that is autonomous travel control without obligation for the driver to monitor surroundings and is performed only in traffic congestion, is in operation in the automated driving function; and an evacuation control section that is configured to perform first evacuation control of causing the subject vehicle to move to a side of a road on which the subject vehicle is traveling when the abnormal state is grasped in the driving assistance control in operation, and performs second evacuation control of causing the subject vehicle to stop in a subject vehicle lane in which the subject vehicle is traveling when the abnormal state is grasped in the traffic congestion limited control in operation.

According to another aspect of the present disclosure, a non-transitory computer readable storage medium storing an automated driving control program that enables traveling of a subject vehicle by an automated driving function is provided. The automated driving control program causing at least one processor to perform processing includes the steps of: grasping an abnormal state of physical condition caused in a driver of the subject vehicle; grasping whether driving assistance control with obligation for the driver to monitor surroundings, or traffic congestion limited control that is autonomous travel control without obligation for the driver to monitor surroundings and is performed only in traffic congestion, is in operation in the automated driving function; and performing first evacuation control of causing the subject vehicle to move to a side of a road on which the subject vehicle is traveling when the abnormal state is grasped in the driving assistance control in operation, and performing second evacuation control of causing the subject vehicle to stop in a subject vehicle lane in which the subject vehicle is traveling when the abnormal state is grasped in the traffic congestion limited control in operation.

These aspects cause the first evacuation control of moving the subject vehicle to a side of the road on which the subject vehicle is traveling to be performed when an abnormal state is grasped in the driving assistance control in operation, so that a risk of rear-end collision from rear can be reduced. In contrast, when an abnormal state is grasped while the traffic congestion limited control is performed, the second evacuation control is performed to stop the subject vehicle in a subject vehicle lane in which the subject vehicle is traveling. During traffic congestion, a risk of rear-end collision can be suppressed to be low even when the subject vehicle stops in the subject vehicle lane. As described above, when control contents of the automated evacuation control are changed according to a situation in which the subject vehicle travels, anxiety of the passenger when the driver is brought into an abnormal state can be alleviated.

According to another aspect of the present disclosure, an automated driving control device that enables traveling of a subject vehicle by an automated driving function is provided. The automated driving control device comprises: an input grasping section that is configured to grasp an input of operation of a driver of the subject vehicle, the input instructing a start of autonomous travel control without obligation for the driver to monitor surroundings; a physical condition abnormality grasping section that is configured to grasp an abnormal state of physical condition of the driver; and a permission determination section that is configured to permit a start of the autonomous travel control based on the input of operation of the driver when a plurality of start permission conditions including at least a driver condition related to a state of the driver is satisfied. The permission determination section starts the autonomous travel control when the abnormal state is grasped even without grasping of the input of operation of the driver as long as the start permission conditions excluding the driver condition are satisfied.

According to another aspect of the present disclosure, a non-transitory computer readable storage medium storing an automated driving control program that enables traveling of a subject vehicle by an automated driving function is provided. The automated driving control program causing at least one processor to perform processing includes the steps of: grasping an input of operation a driver of the subject vehicle for instructing a start of autonomous travel control without obligation for the driver to monitor surroundings; permitting a start of the autonomous travel control based on the input of operation of the driver when a plurality of start permission conditions including at least a driver condition related to a state of the driver is satisfied; grasping an abnormal state of physical condition caused in the driver; and starting the autonomous travel control when the abnormal state is grasped even without grasping of the input of operation of the driver as long as the start permission conditions excluding the driver condition are satisfied.

These aspects start the autonomous travel control without the obligation to monitor the surroundings when an abnormal state of the driver is grasped even without grasping input of driver operation as long as the start permission conditions excluding the driver condition are satisfied. Thus, after the abnormal state occurs, traveling under the autonomous travel control can be quickly started. As a result, anxiety of a passenger can be alleviated when a driver is brought into an abnormal state.

According to another aspect of the present disclosure, a function control device used in a subject vehicle capable of traveling by an automated driving function is provided. The function control device comprises: an information acquisition section that is configured to acquire state information on a driver of the subject vehicle based on a driver image obtained by photographing the driver and steering information related to a steering operation to a steering portion performed by the driver; and an abnormality detection section that is configured to detect an abnormality of the driver based on a plurality of pieces of driver information including at least the state information and the steering information. The abnormality detection section removes the steering information from the driver information used for abnormality detection of the driver when the automated driving function causes the subject vehicle to travel without obligation for the driver to grip the steering portion.

According to another aspect of the present disclosure, a non-transitory computer readable storage medium storing a function control program used in a subject vehicle capable of traveling by an automated driving function is provide. The function control program causing at least one processor to perform processing includes the steps of: acquiring state information on a driver of the subject vehicle based on a driver image obtained by photographing the driver and steering information related to a steering operation to a steering portion performed by the driver; detecting an abnormality of the driver based on a plurality of pieces of driver information including at least the state information and the steering information; and removing the steering information from the driver information used for abnormality detection of the driver when the automated driving function causes the subject vehicle to travel without obligation for the driver to grip the steering portion.

These aspects detect abnormality of the driver based on the driver information except for steering information when the subject vehicle travels without obligation for the driver to grip a steering portion. Thus, these aspects enable avoiding a situation where abnormality is erroneously detected due to using steering information for abnormality detection even in a situation where the driver does not grip the steering portion. As described above, anxiety of the passenger due to false detection of abnormality is less like to occur.

According to another aspect of the present disclosure, an automated driving control device that enables traveling of a subject vehicle by an automated driving function is provided. The automated driving control device comprises: a physical condition abnormality grasping section that is configured to grasp that an abnormality is detected in a driver of the subject vehicle; a notification issuance section that is configured to issue grip request notification for prompting the driver to grip a steering portion when abnormality of the driver is detected in an automated driving period in which the subject vehicle travels without obligation for the driver to monitor surroundings; and a control continuation section that is configured to continue traveling without the obligation for the driver to monitor the surroundings even when an abnormality of the driver is detected in the automated driving period.

According to another aspect of the present disclosure, a non-transitory computer readable storage medium storing an automated driving control program that enables traveling of a subject vehicle by an automated driving function is provided. The automated driving control program causing at least one processor to perform processing includes the steps of: grasping that an abnormality is detected in a driver of the subject vehicle; issuing grip request notification for prompting the driver to grip a steering portion when abnormality of the driver is detected in an automated driving period in which the subject vehicle travels without obligation for the driver to monitor surroundings; and continuing traveling without the obligation for the driver to monitor the surroundings even when an abnormality of the driver is detected in the automated driving period.

These aspects issue grip request notification for prompting the driver to grip the steering portion when abnormality of the driver is detected in an automated driving period in which the subject vehicle travels without obligation for the driver to monitor the surroundings. Thus, when the driver is normal, the abnormality detection can be resolved. Then, even when abnormality of the driver is detected during the automated driving period, traveling in a state without the obligation to monitor the surroundings is continued. As a result, even when physical condition of the driver become abnormal, stable traveling is continued, and thus anxiety of the driver can be alleviated.

Hereinafter, a plurality of embodiments will be described with reference to the drawings. Corresponding components in each embodiment may be denoted by identical reference numerals to eliminate duplicated description. When only a part of a configuration is described in each embodiment, the configuration includes another part to which a configuration of another embodiment described ahead can be applied. Additionally, combinations of configurations are applicable, the combinations including not only a combination of configurations clarified in descriptions of respective embodiments, but also a combination of parts of configurations of a plurality of embodiments, the parts being not clarified and the combination causing no problem.

### First Embodiment

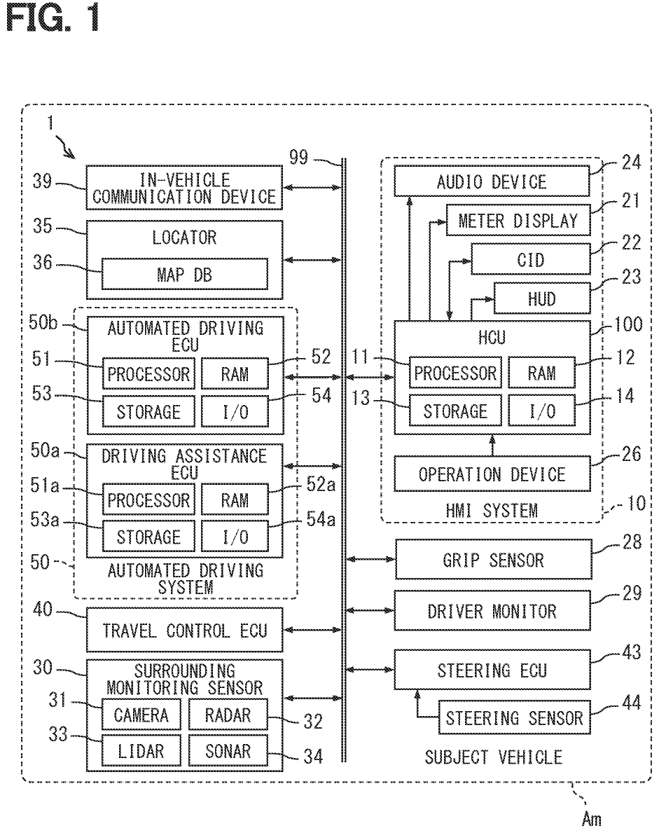

An automated driving control device according to a first embodiment of the present disclosure has functions that are implemented by an automated driving electronic control unit (ECU) 50b illustrated in FIG. 1. The automated driving ECU 50b is mounted on a vehicle (referred to below as a subject vehicle Am) together with a driving assistance ECU 50a. The automated driving ECU 50b constitutes an automated driving system 50 of the subject vehicle Am together with the driving assistance ECU 50a and the like. The subject vehicle Am serves as an automated driving vehicle including an automated driving function by mounting the automated driving system 50, and can travel by the automated driving function.

The driving assistance ECU 50a is an in-vehicle ECU that implements a driving assistance function for assisting driving operation of a driver in the automated driving system 50. The driving assistance ECU 50a enables advanced driving assistance or partial automated driving of about a level 2 at an automated driving level defined by the American Society of Automotive Engineers. The driving assistance ECU 50a performs the automated driving with obligation to monitor the surroundings, the obligation requiring the driver to visually monitor the surroundings of the subject vehicle.

The automated driving ECU 50b is an in-vehicle ECU that implements an autonomous traveling function capable of performing driving operation on behalf of the driver. The automated driving ECU 50b is capable of performing autonomous traveling at a level 3 or higher at which control is mainly performed by a system. The automated driving ECU 50b performs automated driving that does not require monitoring of the surroundings of the subject vehicle, or that is an eyes-off automated driving without the obligation to monitor the surroundings.

The automated driving system 50 switches a travel control state of the automated driving function among a plurality of states including at least driving assistance control with the obligation to monitor the surroundings using the driving assistance ECU 50a and autonomous travel control without the obligation to monitor the surroundings using the automated driving ECU 50b. The description below shows automated driving control at the level 2 or lower using the driving assistance ECU 50a that is referred to as “driving assistance control”, and automated driving control at the level 3 or higher using the automated driving ECU 50b that is referred to as “autonomous travel control”. The automated driving ECU 50b may be capable of performing automated driving at a level 4 or higher.

During a period of automated traveling in which the subject vehicle Am travels under the autonomous travel control using the automated driving ECU 50b, the driver can be permitted to perform a specific action (referred to below as a second task) other than predetermined driving. The second task is legally permitted to the driver until the automated driving ECU 50b requires driving operation to be performed in cooperation with a human machine interface control unit (HCU) 100 described later, or requires substitution of driving. Assumed examples of the second task include viewing entertainment content such as moving image content, operation of a device such as a smartphone, and action such as eating.

The driving assistance ECU 50a and the automated driving ECU 50b are communicably connected to a communication bus 99 of an in-vehicle network 1 mounted on the subject vehicle Am. As illustrated in FIGS. 1 to 3, the communication bus 99 is connected to a grip sensor 28, a driver monitor 29, a surrounding monitoring sensor 30, a locator 35, an in-vehicle communication device 39, a travel control ECU 40, a steering ECU 43, the HCU 100, and the like. The communication bus 99 is connected to nodes thereof that can communicate with each other. Specific nodes among these components such as the ECU may be electrically connected directly to each other to enable communicating with each other without passing through the communication bus 99.

The grip sensor 28 is a capacitive touch sensor, for example. The grip sensor 28 is provided on a rim portion of a steering wheel. The grip sensor 28 detects whether a driver grips the steering wheel. The grip sensor 28 provides the HCU 100 and the like with grip detection information indicating whether the driver grips the steering wheel.

The driver monitor 29 includes a near-infrared light source, a near-infrared camera, and a control unit that controls these components. The driver monitor 29 is installed on an upper surface of a steering column portion or an upper surface of an instrument panel, for example, in an attitude in which the near-infrared camera faces a headrest of a driver's seat. The driver monitor 29 may be integrated with a meter display 21, a center information display (CID) 22, or the like to be described later, while being provided on any one of screens of the displays.

The driver monitor 29 allows the near-infrared camera to capture an image of the head of the driver irradiated with near-infrared light emitted by the near-infrared light source. The image (driver image) captured by the near-infrared camera is subjected to image analysis using the control unit. The control unit extracts information such as a position and a line-of-sight direction of an eye point of the driver from the image captured. The driver monitor 29 provides the HCU 100, the automated driving ECU 50b, and the like with the information on a driver status extracted by the control unit.

The surrounding monitoring sensor 30 is an autonomous sensor that monitors a surrounding environment of the subject vehicle Am. The surrounding monitoring sensor 30 can detect a moving object and a stationary object from a detection range around the subject vehicle. The surrounding monitoring sensor 30 can detect at least other vehicles traveling around the subject vehicle Am, specifically, a preceding vehicle, a following vehicle, a laterally adjacent vehicle, and the like. The surrounding monitoring sensor 30 provides the driving assistance ECU 50a, the automated driving ECU 50b, and the like with detection information on an object around the subject vehicle.

The surrounding monitoring sensor 30 includes one or more of a camera unit 31, a millimeter wave radar 32, a lidar 33, and a sonar 34, for example. The camera unit 31 may include a monocular camera or a compound-eye camera. The camera unit 31 is mounted on the subject vehicle Am while being capable of capturing an image of a forward range of the subject vehicle Am. The subject vehicle Am may be equipped with the camera unit 31 capable of capturing images of a lateral range and a backward range of the subject vehicle Am. The camera unit 31 outputs at least one of imaging data obtained by capturing an image of the surroundings of the subject vehicle and an analysis result of the imaging data as detection information.

The millimeter wave radar 32 emits a millimeter wave or a quasi-millimeter wave toward the surroundings of the subject vehicle. The millimeter wave radar 32 outputs detection information generated by processing of receiving a reflected wave reflected by a moving object, a stationary object, or the like. The lidar 33 emits laser light toward the surroundings of the subject vehicle. The lidar 33 outputs detection information generated by processing of receiving laser light reflected by a moving object, a stationary object, or the like existing in an irradiation range. The sonar 34 emits an ultrasonic wave toward the surroundings of the subject vehicle. The sonar 34 outputs detection information generated by processing of receiving an ultrasonic wave reflected by a moving object, a stationary object, or the like existing near the subject vehicle.

The locator 35 includes a global navigation satellite system (GNSS) receiver, an inertial sensor, and the like. The locator 35 combines a positioning signal received by the GNSS receiver, a measurement result of the inertial sensor, vehicle speed information output to the communication bus 99, and the like to sequentially measure a position, a traveling direction, and the like of the subject vehicle Am. The locator 35 sequentially outputs position information and direction information on the subject vehicle Am based on the measurement result to the communication bus 99 as locator information.

The locator 35 further includes a map database (referred to below as a map DB) 36 storing map data. The map DB 36 mainly includes a large-capacity storage medium storing many pieces of three-dimensional map data and two-dimensional map data. The three-dimensional map data includes information necessary for advanced driving assistance and automated driving, such as three-dimensional shape information of a road and detailed information on each lane. The locator 35 reads out map data around a current position from the map DB 36, and provides the driving assistance ECU 50a, the automated driving ECU 50b, and the like with the map data together with the locator information.

The in-vehicle communication device 39 is an externally-communicating unit mounted on the subject vehicle Am, and functions as a vehicle to everything (V2X) communication device. The in-vehicle communication device 39 transmits and receives information to and from a roadside device installed on a side of a road by wireless communication. For example, the in-vehicle communication device 39 receives information from the roadside device, the information being on traffic congestion around the current position and in a traveling direction of the subject vehicle Am. The information on traffic congestion is VICS (registered trademark) information or the like. The in-vehicle communication device 39 provides the automated driving ECU 50b and the like with the received information on traffic congestion.

The travel control ECU 40 is an electronic control device mainly including a microcontroller. The travel control ECU 40 has at least functions of a brake control ECU, and a drive control ECU. The travel control ECU 40 continuously performs braking force control of each wheel, output control of an in-vehicle power source, and steering angle control, based on any one of an operation command based on driving operation of the driver, a control command of the driving assistance ECU 50a, and a control command of the automated driving ECU 50b. The travel control ECU 40 also generates vehicle speed information indicating current traveling speed of the subject vehicle Am based on a detection signal of a wheel speed sensor provided in a hub portion of each wheel, and sequentially outputs the generated vehicle speed information to the communication bus 99.

The steering ECU 43 is provided in a steering control system of the subject vehicle Am, and includes a microcontroller as a main component. The steering ECU 42 controls operation of a steering actuator based on at least one of the steering operation performed by the driver and the control command acquired from the driving assistance ECU 50a to define a direction of the steering wheel and thus a traveling direction of the subject vehicle Am. The steering ECU 43 sequentially outputs, to the communication bus 99, input torque (referred to below as steering torque) to the steering wheel detected by a steering sensor 44, and operation information (referred to below as steering information) indicating a rotation direction and a rotation angle (steering wheel angle) of the steering wheel.

The HCU 100 constitutes a human machine interface (HMI) system 10 together with a plurality of display devices, an audio device 24, an operation device 26, and the like. The HMI system 10 has an input interface function of receiving an operation of a passenger such as a driver of the subject vehicle Am and an output interface function of presenting information to the driver.

The display device presents information through vision of the driver using image display or the like. The display device includes the meter display 21, the CID 22, a head-up display (referred to as an HUD) 23, and the like. The CID 22 has functions of a touch panel, and detects a touch operation of a driver or the like on a display screen. The audio device 24 includes a plurality of speakers installed in a vehicle interior in a placement surrounding the driver's seat, and causes the speakers to reproduce a notification sound, a voice message, or the like in the vehicle interior.

The operation device 26 is an input portion that receives a user operation of a driver or the like. The operation device 26 receives a user operation or the like related to operation and stop of the automated driving function, for example. For example, the operation device 26 receives a driver input for instructing a transition from the driving assistance control to the autonomous travel control. The operation device 26 includes a steering switch provided on a spoke portion of a steering wheel, an operation lever provided on a steering column portion, a voice input device that recognizes utterance content of a driver, and the like.

The HCU 100 functions as a presentation control device, and integrally manages presentation of information and the like related to automated driving to a driver. The HCU 100 requires substitution of driving for the driver based on a request to perform driving operation using the automated driving ECU 50b. The HCU 100 also permits a driver to perform the second task in cooperation with the automated driving ECU 50b, and thus enables reproducing moving image content or the like related to the second task without interfering with a requirement for substitution of driving.

The HCU 100 mainly includes a control circuit including a processor 11, a RAM 12, a storage 13, an input/output interface 14, a bus for connecting these, and the like. The processor 11 is hardware coupled to the RAM 12 to perform arithmetic processing. The processor 11 includes at least one of arithmetic cores such as a central processing unit (CPU) and a graphics processing unit (GPU). The processor 11 may further include a field-programmable gate array (FPGA), a neural network processing unit (NPU), an IP core having another dedicated function, and the like. The RAM 12 may include a video RAM for generating video data. The processor 11 performs various types of processing for implementing a presentation control method and a function control method of the present disclosure by accessing the RAM 12. The storage 13 includes a nonvolatile storage medium. The storage 13 stores various programs (such as a presentation control program) to be executed by the processor 11.

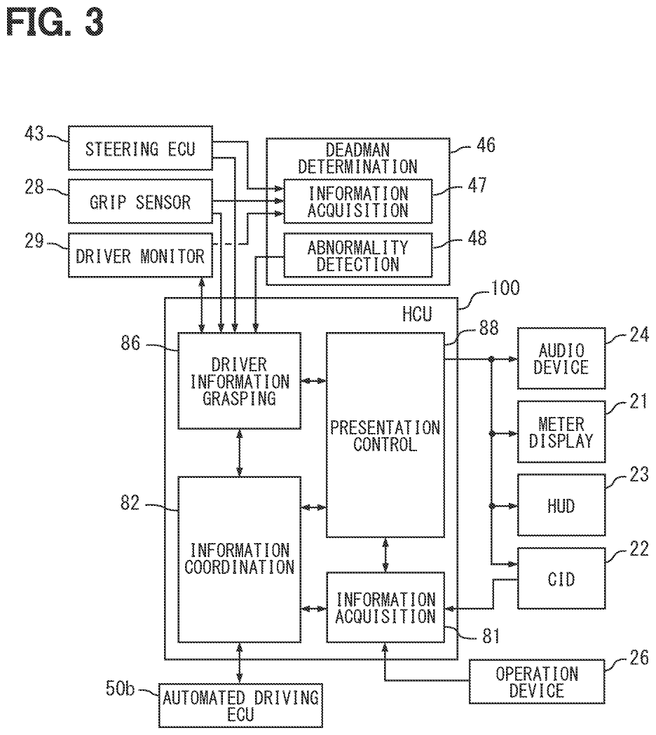

The HCU 100 includes a plurality of functional sections that integrally controls information presentation to a driver by causing the processor 11 to execute a presentation control program stored in the storage 13. Specifically, the HCU 100 includes the functional sections such as an information acquisition section 81, an information coordination section 82, a driver information grasping section 86, and a presentation control section 88 (see FIG. 3).

The information acquisition section 81 acquires vehicle information indicating a state of the subject vehicle Am from the communication bus 99. The vehicle information includes vehicle speed information provided to the communication bus 99 by the travel control ECU 40, for example. The information acquisition section 81 also acquires operation information indicating content of user operation from the CID 22, the operation device 26, and the like.

The information coordination section 82 coordinates with an information coordination section 61 (described later) of the automated driving ECU 50b to enable information to be shared between the automated driving system 50 and the HCU 100. The information coordination section 82 provides the automated driving ECU 50b with operation information grasped by the information acquisition section 81, driver monitoring information (described later) grasped by the driver information grasping section 86, and the like.

The information coordination section 82 acquires control status information indicating a state of the automated driving function to grasp an operation state of the automated driving by the automated driving system 50. Based on the control status information, the information coordination section 82 grasps whether the travel control in operation is the driving assistance control or the autonomous travel control, in other words, whether the travel control performed by the automated driving function requires a driver to have the obligation to monitor the surroundings.

The information coordination section 82 acquires a request to issue notification, the request being output by a notification request section 73 (described later) of the automated driving ECU 50b. The information coordination section 82 acquires requests from the automated driving ECU 50b, the requests including a request for the driver to require substitution of driving, a request to issue control transition notification, and the like. The control shift notification relates to a transition from manual driving to the driving assistance control and a transition from the driving assistance control to the autonomous travel control, for example. The information coordination section 82 controls content and timing of performing each notification in cooperation with the presentation control section 88 based on the request to issue each notification.

The driver information grasping section 86 grasps a state and action of a driver based on grip detection information acquired from the grip sensor 28 and driver status information acquired from the driver monitor 29. The driver information grasping section 86 may acquire steering information from the steering ECU 43 instead of or together with the grip detection information. The driver information grasping section 86 grasps whether the driver grips the steering wheel, and whether the driver monitors the surroundings of the subject vehicle Am, for example, based on the grip detection information, the driver status information, and the like sequentially acquired. The driver information grasping section 86 also grasps an abnormal state caused in physical condition of the driver based on abnormality detection information acquired from a deadman determination section 46 (described later) in a period of the manual driving, a period of the driving assistance, and a period of the automated traveling. The information coordination section 82 and the presentation control section 88 are provided with driver monitoring information including information indicating whether the steering wheel is gripped, whether monitoring of the surroundings is performed, whether an abnormal state occurs, and the like.

The presentation control section 88 integrally controls provision of information to a driver using each display device and the audio device 24. The presentation control section 88 provides content and information corresponding to an operating state of the automated driving based on the control status information and the request to issue each notification acquired by the information coordination section 82, the driver monitoring information grasped by the driver information grasping section 86, and the like. Specifically, the presentation control section 88 enables the display device to reproduce moving image content or the like when the information coordination section 82 grasps that the automated driving ECU 50b performs the autonomous travel control. The presentation control section 88 also performs a requirement for substitution of driving that requests the driver to substitute driving when the autonomous travel control without the obligation to monitor the surroundings is scheduled to be released.

Next, details of the driving assistance ECU 50a and the automated driving ECU 50b will be described in order.

The driving assistance ECU 50a is a computer mainly including a control circuit including a processor 51a, a RAM 52a, a storage 53a, an input/output interface 54a, a bus connecting these components, and the like. The driving assistance ECU 50a implements a plurality of driving assistance functions by executing a program in the processor 51a. Specifically, driving support functions such as adaptive cruise control (ACC), lane trace control (LTC), and lane change assist (LCA) are implemented. For example, the driving assistance ECU 50a performs driving assistance control for causing the subject vehicle Am to travel along a subject vehicle lane Lns in which the subject vehicle Am is traveling by cooperation of the functions of the ACC and the LTC.

The driving assistance ECU 50a includes the deadman determination section 46 (see FIG. 3). The deadman determination section 46 is a functional section constructed according to a deadman determination program stored in the storage 53a as one of function control programs. The deadman determination section 46 functions as abnormality detection device that automatically detects that the driver is in a difficult-to-drive state due to a reason difficult to predict in advance such as a seizure to diagnose that the driver is in a difficult-to-drive state. The deadman determination section 46 further includes an information acquisition section 47 and abnormality detection section 48 as sub-functional sections.

The information acquisition section 47 acquires, from the driver monitor 29, state information on the driver (referred to below as driver status information) based on a driver image obtained by photographing the driver of the subject vehicle Am. The information acquisition section 47 acquires, from the steering ECU 43, steering information related to a steering operation to the steering wheel performed by the driver. The information acquisition section 47 also acquires, from the grip sensor 28, the grip detection information indicating whether the driver grips the steering wheel as one of the steering information.

The abnormality detection section 48 detects abnormality of the driver based on a plurality of pieces of driver information including at least the driver status information and the steering information. The abnormality detection section 48 detects inclination of the upper body of the driver, inclination of the head with respect to the upper body, and the like based on the driver status information to grasp inappropriate posture of the driver. The abnormality detection section 48 grasps a degree of eye opening or a degree of wakefulness of the driver based on the driver status information. The abnormality detection section 48 grasps whether the driver appropriately continues the steering operation based on the steering information. The abnormality detection section 48 detects abnormalities of the driver, such as occurrence of inappropriate posture, a decrease in the degree of eye opening or the degree of wakefulness to a predetermined level or less, and interruption of steering operation. When detecting abnormality of the driver, the abnormality detection section 48 provides the abnormality detection information indicating the abnormality detection to the driver information grasping section 86 through the communication bus 99. When the abnormality is detected, occurrence of abnormal physical condition of the driver is suspected.

When the abnormality of the driver is continuously detected, in other words, when the abnormality of the driver is continuously detected multiple times, the abnormality detection section 48 determines that the driver is in an abnormal physical condition and thus in a difficult-to-drive state. When diagnosing the difficult-to-drive state of the driver, the abnormality detection section 48 provides abnormality detection information indicating the occurrence of the abnormal state to the driver information grasping section 86 through the communication bus 99. As described above, the deadman determination section 46 outputs the abnormality detection information indicating the occurrence of the abnormal state when grasping a state in which the driver changes his/her posture to a posture inappropriate for driving. The deadman determination section 46 further outputs abnormality detection information indicating determination of the difficult-to-drive state when the generated abnormal state (posture change) continues for a predetermined time.

The deadman determination section 46 may be mounted on the automated driving ECU 50b or the HCU 100 as a functional section of these ECUs. Alternatively, a single in-vehicle ECU having the function of the deadman determination section 46 may be connected to the communication bus 99 separately from the driving assistance ECU 50a and the like.

The automated driving ECU 50b has higher calculation capability than the driving assistance ECU 50a, and can perform at least travel control corresponding to the ACC, the LTC, and the LCA. The automated driving ECU 50b also performs minimal risk maneuver (MRM) control as vehicle control when the deadman determination section 46 determines that the driver has fallen into a difficult-to-drive state. The MRM control is automated evacuation control for stopping the subject vehicle Am at the evacuation place. The evacuation place is set in a lane in which the vehicle is traveling, a roadside (a road shoulder) of the road on which the vehicle is traveling, or the like. Settable examples of the evacuation place include an emergency parking zone, a roadside zone, and a parking area.

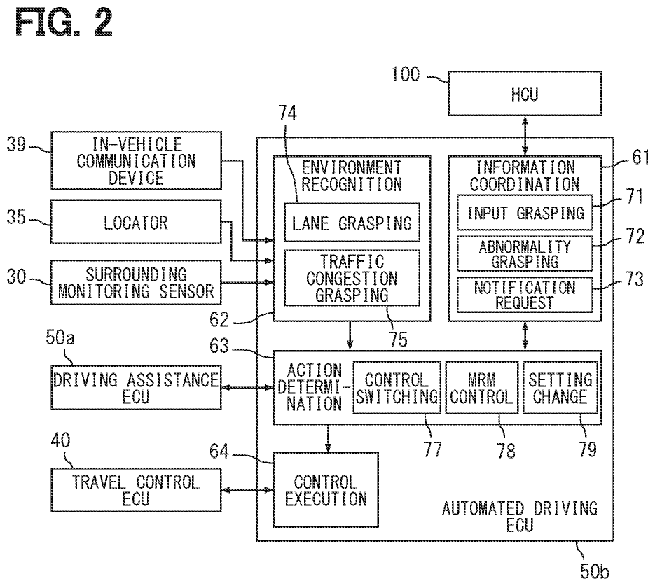

The automated driving ECU 50b is a computer mainly including a control circuit including a processor 51, a RAM 52, a storage 53, an input/output interface 54, a bus connecting these components, and the like. The processor 51 performs various types of processing for implementing an automated driving control method and the function control method of the present disclosure by accessing the RAM 52. The storage 53 stores various programs (such as an automated driving control program and function control program) to be executed by the processor 51. The programs executed by the processor 51 cause the automated driving ECU 50b to include a plurality of functional sections for achieving an automated driving function and control a function related to the automated driving function. Specifically, the automated driving ECU 50b includes an information coordination section 61, an environment recognition section 62, an action determination section 63, a control execution section 64, and the like (see FIG. 2).

The information coordination section 61 provides information to the information coordination section 82 of the HCU 100 and acquires information from the information coordination section 82. Coordination between the information coordination sections 61 and 82 allows the automated driving ECU 50b and the HCU 100 to share the information acquired by each unit. The information coordination section 61 generates control status information indicating an operation state of the automated driving function, and provides the generated control status information to the information coordination section 82. The information coordination section 61 includes sub-function sections for information coordination, the sub-function sections including an input grasping section 71, abnormality grasping section 72, and a notification request section 73.

The input grasping section 71 acquires the operation information from the information coordination section 82. The input grasping section 71 grasps user operation (driver operation) input to the CID 22, the operation device 26, and the like based on the operation information. The input grasping section 71 grasps driver operation (referred to below as level 2 transition operation) instructing to start the driving assistance control, a driver operation (referred to below as level 3 transition operation) instructing to start the autonomous travel control, and the like.

The abnormality grasping section 72 acquires the driver monitoring information from the information coordination section 82. The abnormality grasping section 72 grasps an action of the driver and an abnormal state of physical condition caused in the driver based on the driver monitoring information. Specifically, the abnormality grasping section 72 grasps whether the steering wheel is gripped, whether the driver monitors the surrounding, contents of the second task in operation, and occurrence of an abnormal state and a difficult-to-drive state of the driver.

The abnormality grasping section 72 may have a function similar to that of the driver information grasping section 86 of the HCU 100. More specifically, the abnormality grasping section 72 may be capable of grasping action, physical condition, and the like of the driver as with the driver information grasping section 86 by acquiring the driver status information and the abnormality detection information from each of the driver monitor 29 and the deadman determination section 46.

The notification request section 73 enables notification using the HCU 100 synchronized with an operation state of the automated driving function by outputting a request to issue notification to the information coordination section 82. That is, the notification request section 73 can change contents of information presentation control, which is performed by the HCU 100, in cooperation with the action determination section 63 and in accordance with contents of the vehicle control by the automated driving function. As described above, the notification request section 73 transmits the request to issue notification related to the automated driving to the information coordination section 82, the request including a request to require substitution of driving, a request to issue control transition notification, and the like.

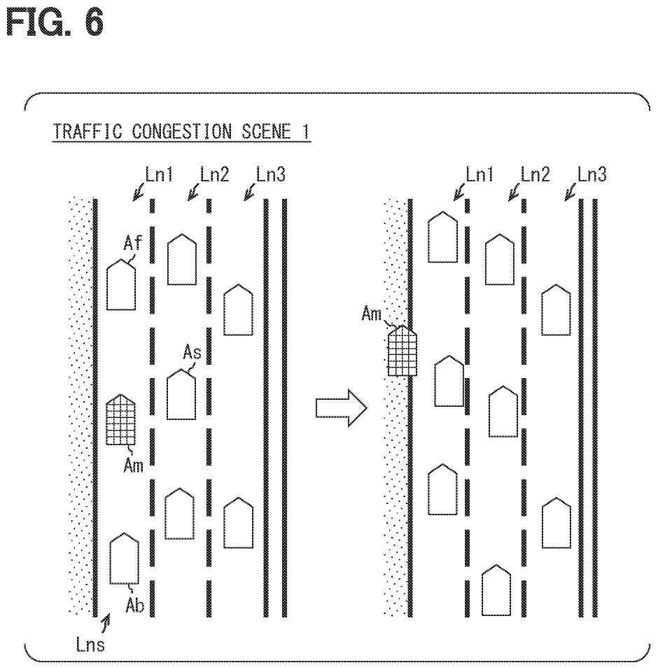

The environment recognition section 62 acquires vehicle information such as vehicle speed information from the communication bus 99 to grasp a current traveling state of the subject vehicle Am. The environment recognition section 62 also combines the locator information and the map data acquired from the locator 35 with the detection information acquired from the surrounding monitoring sensor 30 to recognize a travel environment of the subject vehicle Am. The environment recognition section 62 grasps a relative position, a relative speed, and the like of a dynamic target around a subject vehicle, such as another vehicle traveling around the subject vehicle Am. The environment recognition section 62 grasps at least a preceding vehicle Af and a following vehicle Ab traveling in the same lane as the subject vehicle Am, laterally adjacent vehicles As traveling in right and left lanes adjacent to the lane of the subject vehicle, and the like (see FIG. 6). The environment recognition section 62 includes a lane grasping section 74 and a traffic congestion grasping section 75 as sub-function sections for travel environment recognition.

The lane grasping section 74 grasps information on a road on which the subject vehicle Am travels. The lane grasping section 74 determines whether a road on which the subject vehicle Am travels or a road on which the subject vehicle Am is scheduled to travel is a preset automated driving available area (referred to below as an AD area) or a restricted AD area. The information indicating whether the road is in the AD area or the restricted AD area may be recorded in map data stored in the map DB 36, or may be included in reception information received by the in-vehicle communication device 39.

The AD area and the restricted AD area can correspond to an operational design domain in which automated driving without obligation for a driver to monitor the surroundings is legally permitted. Examples of the automated driving without obligation to monitor the surroundings includes a plurality of travel control modes including traffic congestion limited control (referred to below as a traffic congestion level 3) performed only in traveling in traffic congestion, and area limited control (referred to below as an area level 3) performed only in a specific area. A road in the AD area permits performing both the traffic congestion level 3 and the area level 3, and a road in the restricted AD area permits performing only the traffic congestion level 3. A manual driving area (referred to below as an MD area) other than the AD area and the restricted AD area prohibits traveling in automated driving at the level 3 in principle. The MD area may prohibit traveling in automated driving at the level 2 or higher. The AD area or the restricted AD area is set on an expressway or an automobile exclusive road, for example.

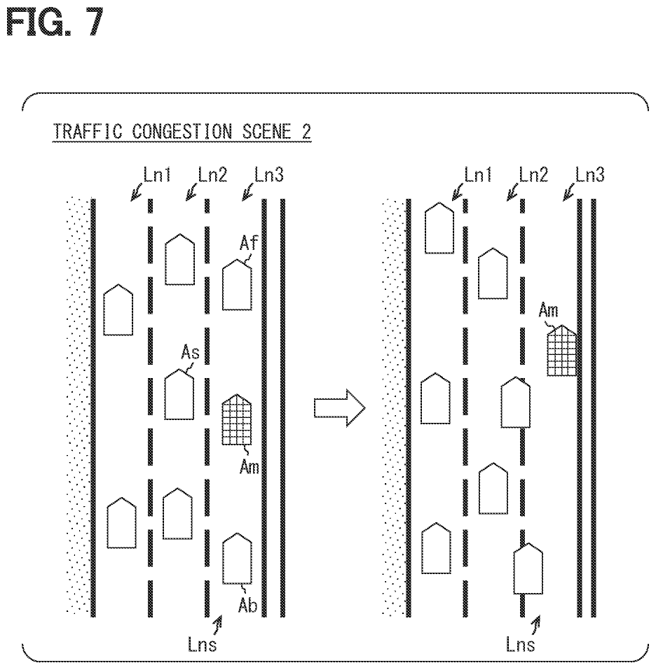

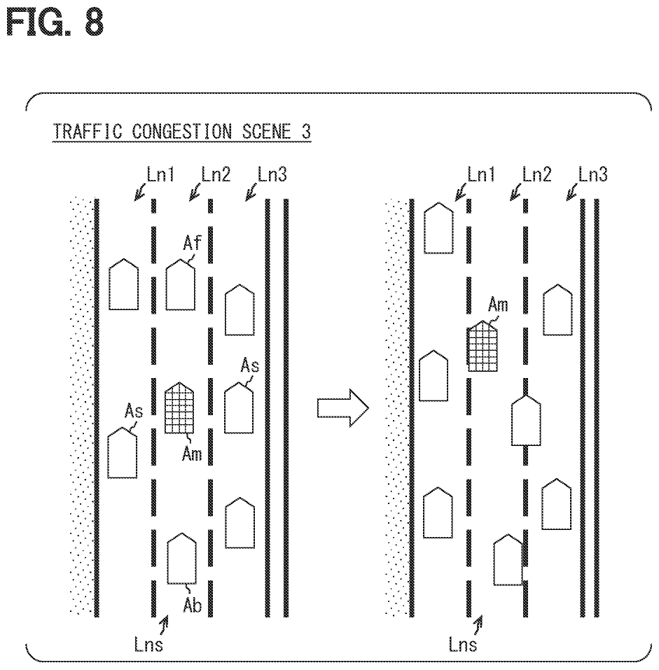

When the subject vehicle Am travels on a road including a plurality of lanes, the lane grasping section 74 grasps a position of a lane on which the subject vehicle Am travels (referred to below as a subject vehicle lane Lns) among the plurality of lanes. Specifically, when the subject vehicle lane Lns is adjacent to a road shoulder of a road including two or more lanes per one direction, the lane grasping section 74 determines that the subject vehicle lane Lns is a road shoulder side lane Ln1 (see FIG. 6). In contrast, when the subject vehicle lane Lns is not adjacent to the road shoulder of the road and is adjacent to a median strip, the lane grasping section 74 determines that the subject vehicle lane Lns is a passing lane Ln3 (see FIG. 7). Then, when there are other lanes on both sides of the subject vehicle lane Lns in a road including three or more lanes per one direction, the lane grasping section 74 determines that the subject vehicle lane Lns is a center lane Ln2 (see FIG. 8).

Specifically, a road of a country where vehicles pass on the left side includes a lane at the left end serving as the road shoulder side lane Ln1, and a lane at the right end serving as the passing lane Ln3. In contrast, a road of a country where vehicles pass on the right side includes a lane at the right end serving as the road shoulder side lane Ln1, and a lane at the left end serving as the passing lane Ln3.

The traffic congestion grasping section 75 grasps traffic congestion around the subject vehicle Am by combining vehicle speed information grasped by the environment recognition section 62 with information on other vehicles, and the like. The traffic congestion grasping section 75 may use traffic congestion information received by the in-vehicle communication device 39 to grasp the traffic congestion around the subject vehicle. When the traffic congestion grasping section 75 grapes traffic congestion around the subject vehicle Am in the AD area or the restricted AD area, automated traveling under the autonomous travel control at the traffic congestion level 3 can be performed.

The traffic congestion grasping section 75 determines that the surroundings of the subject vehicle are in a traffic congestion state when the subject vehicle Am is traveling at a speed equal to or lower than traffic congestion speed (e.g., about 30 km/h) and both a preceding vehicle Af and a following vehicle Ab travel in the subject vehicle lane Lns (see FIG. 6). When traveling speed of the subject vehicle Am exceeds the traffic congestion speed after determination that the surroundings of the subject vehicle are in the traffic congestion state, the traffic congestion grasping section 75 predicts that the traffic congestion around the subject vehicle will clear. After predicting that the traffic congestion will clear, the traffic congestion grasping section 75 cancels the prediction that the traffic congestion will clear when vehicle speed of the subject vehicle Am decreases to equal to or lower than the traffic congestion speed again. Then, the traffic congestion grasping section 75 determines that the traffic congestion has cleared when the traveling speed of the subject vehicle Am exceeds traffic congestion clear speed (e.g., about 50 km/h) after predicting that the traffic congestion will clear.

The action determination section 63 cooperates with the HCU 100 to control substitution of driving between the automated driving system 50 and the driver. When the automated driving system 50 has a right to control driving operation, the action determination section 63 generates a planned traveling line on which the subject vehicle Am travels based on a recognition result of a traveling environment, the recognition result being recognized by the environment recognition section 62, and outputs the generated planned traveling line to the control execution section 64. The action determination section 63 includes a control switching section 77, an MRM control section 78, and a setting change section 79 as sub-function sections for controlling an operation state of the automated driving function.

The control switching section 77 has a function of grasping a control state of the automated driving performed by the automated driving system 50 and a function of switching the control state of the automated driving among a plurality of levels and travel control modes. Specifically, the control switching section 77 grasps whether the automated driving function performs the driving assistance control with obligation to monitor the surroundings or the autonomous travel control without the obligation to monitor the surroundings. The control switching section 77 also grasps a travel control mode being performed by the automated driving function in an automated traveling period, the travel control mode being selected among the plurality of travel control modes included in the autonomous travel control. That is, the control switching section 77 grasps whether the traffic congestion level 3 is in operation or the area level 3 is in operation in the automated traveling period.

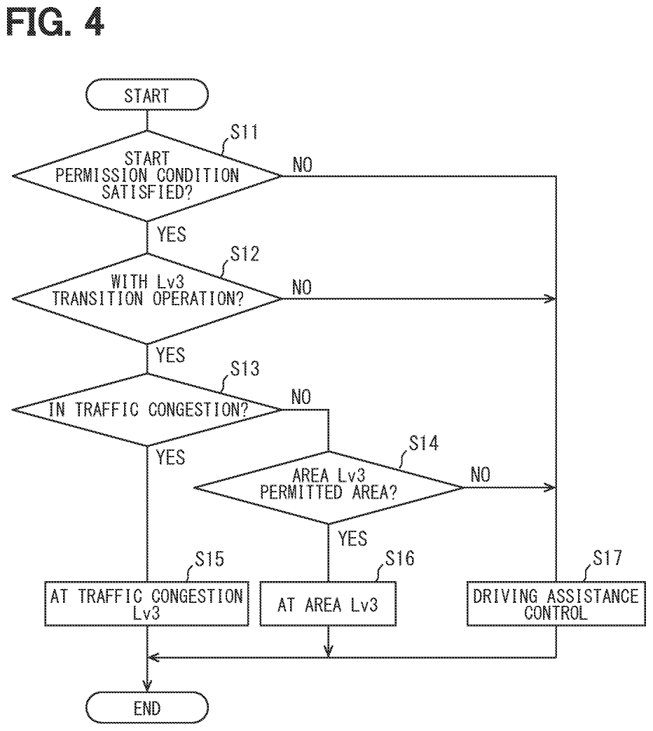

The control switching section 77 controls a start and an end of each of the driving assistance control and the autonomous travel control. The control switching section 77 switches control between the driving assistance control with obligation for the driver to monitor the surroundings and the autonomous travel control without the obligation for the driver to monitor the surroundings. When the subject vehicle Am is caused to travel under the autonomous travel control, the control switching section 77 switches a travel control mode among the plurality of travel control modes including the area level 3 and the traffic congestion level 3. Specifically, the control switching section 77 switches a travel control state of the automated driving function among a plurality of states in cooperation with the driving assistance ECU 50a by performing driving control switching processing (see FIG. 4). The control switching section 77 starts the driving control switching processing based on a start of the driving assistance control performed by the driving assistance ECU 50a, for example.

The driving control switching processing allows the control switching section 77 to determine whether a start permission condition of the level 3 is satisfied (S11). The control switching section 77 preliminarily sets a plurality of the start permission conditions for permitting a transition to the autonomous travel control. The plurality of the start permission conditions includes a driver condition related to a state of the driver, a vehicle condition related to a state of the subject vehicle Am, and an environmental condition related to a travel environment around the subject vehicle. For example, when the subject vehicle Am is traveling in the MD area or when the driver takes an inappropriate driving posture, the control switching section 77 determines that the start permission condition is not satisfied (S11: NO). In this case, the control switching section 77 does not permit the autonomous travel control to be performed, and continues the driving assistance control performed by the driving assistance ECU 50a (S17).

In contrast, when all of the driver condition, the vehicle condition, and the environmental condition described above are satisfied, the control switching section 77 determines that the start permission condition is satisfied (S11: YES). In this case, it is determined whether the input grasping section 71 grasps the level 3 transition operation (S12). When the input grasping section 71 grasps the level 3 transition operation (S12: YES), the control switching section 77 permits a start of the autonomous travel control based on input of the level 3 transition operation and selects a travel control mode to be performed.

When traffic congestion around the subject vehicle is grasped by the traffic congestion grasping section 75 (S13: YES), the control switching section 77 performs the autonomous travel control at the traffic congestion level 3 (S15). In contrast, when the traffic congestion around the subject vehicle is not grasped (S13: NO), the control switching section 77 determines whether the subject vehicle Am is traveling in the AD area (S14). When the subject vehicle Am is traveling in the restricted AD area (S14: NO), the control switching section 77 cancels the permission to start the autonomous travel control and continues the driving assistance control performed by the driving assistance ECU 50a (S17). In contrast, when the subject vehicle Am is traveling in the AD area (S14: YES), the control switching section 77 performs autonomous travel control at the area level 3 (S16).

The MRM control section 78 performs the MRM control described above as the vehicle control when an abnormal state of the driver is grasped. The MRM control section 78 starts preparation for a transition to the MRM control based on abnormality detection information indicating occurrence of the abnormal state, and starts the MRM control based on the abnormality detection information indicating determination of the difficult-to-drive state. The transition preparation is performed by processing of searching for and setting an evacuation place, for example.

The MRM control section 78 can change contents of a series of control performed in the MRM control. The MRM control section 78 performs the MRM control (referred to below also as second evacuation control) as one implementation pattern that causes an evacuation place to be set in the subject vehicle lane Lns in which the subject vehicle Am is traveling and the subject vehicle Am to be stopped in the subject vehicle lane Lns. The MRM control section 78 performs the MRM control (referred to below also as first evacuation control) as another implementation pattern that causes the subject vehicle Am to be stopped on a road shoulder. The first evacuation control when the subject vehicle lane Lns is not adjacent to the road shoulder causes a lane change to the road shoulder side lane Ln1 (see FIG. 6) to be performed. The MRM control section 78 can change the implementation pattern of the MRM control among a plurality of patterns including at least the first evacuation control and the second evacuation control according to a situation of each of the subject vehicle Am, the traveling environment, and the like.

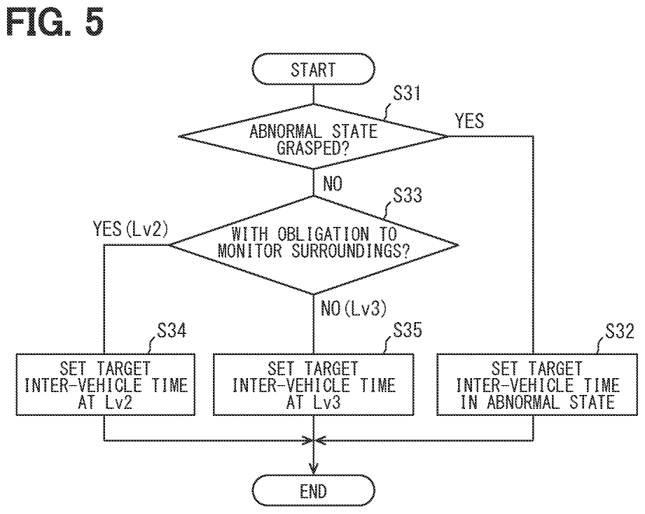

The setting change section 79 changes setting of a parameter related to the autonomous travel control based on information grasped by the information coordination section 61 and the environment recognition section 62. The setting change section 79 sets an inter-vehicle distance to the preceding vehicle Af during follow-up traveling as one of parameters related to the autonomous travel control. The setting change section 79 changes the setting of the inter-vehicle distance in accordance with a travel control state in cooperation with the driving assistance ECU 50a by performing inter-vehicle distance setting processing (see FIG. 5). The inter-vehicle distance setting processing is started by the setting change section 79, for example, based on that the driving assistance ECU 50a starts the driving assistance control.

The inter-vehicle distance setting processing allows the setting change section 79 to determine whether an abnormal state (inappropriate posture) of physical condition of the driver is grasped by the abnormality grasping section 72 (S31). When abnormality of the physical condition of the driver is grasped (S31: YES), the setting change section 79 sets a target inter-vehicle time associated with the MRM control (S32). Setting of the inter-vehicle distance when an abnormal state is grasped is wider than setting of the inter-vehicle distance in each of the autonomous travel control and the driving assistance control. As described above, the inter-vehicle distance between the subject vehicle Am and the preceding vehicle Af starts increasing at a stage of the preparation for the transition to the MRM control. As also described later, the inter-vehicle distance is set wider in transition preparation when the area level 3 is in operation than in transition preparation when the traffic congestion level 3 is in operation.

When no abnormality of the physical condition of the driver is grasped (S31: NO), it is determined whether a current travel control state requires obligation to monitor the surroundings (S33). When the current travel control state requires the obligation to monitor the surroundings (S33: YES), the setting change section 79 cooperates with the driving assistance ECU 50a to set a target inter-vehicle time associated with the driving assistance control (S34). In contrast, when the current travel control state is without obligation to monitor the surroundings (S33: NO), the setting change section 79 sets a target inter-vehicle time associated with the autonomous travel control at the level 3 (S35). Setting of the inter-vehicle distance in the autonomous travel control is wider than setting of the inter-vehicle distance in the driving assistance control.

Here, the above description, “the inter-vehicle distance is set wider”, means that control is performed to secure a wider inter-vehicle distance under a condition with an equal parameter such as traveling speed of the subject vehicle Am affecting the inter-vehicle distance. For example, setting of an inter-vehicle distance during follow-up traveling can be changed by the driver in three stages such as “long (far), intermediate, and short (close)”, or in five stages such as “long, slightly long, intermediate, slightly short, and short”. Processing of automatically adjusting the setting of the inter-vehicle distance in the inter-vehicle distance setting processing may be performed to change the setting of an inter-vehicle distance.

When the automated driving ECU 50b has a right to control driving operation, the control execution section 64 performs acceleration and deceleration control, steering control, and the like of the subject vehicle Am in accordance with the planned traveling line generated by the action determination section 63 in cooperation with the travel control ECU 40. Specifically, the control execution section 64 generates a control command based on the planned traveling line, and sequentially outputs the generated control command to the travel control ECU 40.

Next, details of a series of processing from when the deadman determination section 46 detects an abnormal state to when the MRM control is started based on determination of a difficult-to-drive state will be further described.

When an abnormal state (inappropriate posture) of the physical condition of the driver is grasped based on the abnormality detection information, the automated driving ECU 50b sets an idle period until the MRM control is started. The idle period allows preparation for a transition to the MRM control to be performed as described above. The idle period also allows the automated driving ECU 50b and the HCU 100 to cooperate with each other to issue improvement request notification for requesting the driver to improve his/her state. The improvement request notification causes the audio device 24 to reproduce a voice message such as “Please maintain a correct driving posture”. The improvement request notification also causes the display device to display a message image having the same content as the voice message. The improvement request notification may be presented only to the driver or may be presented to a passenger except for the driver.

When the abnormal state of the driver is improved before the idle period elapses, the automated driving ECU 50b does not perform the transition to the MRM control. The automated driving ECU 50b in this case starts automated driving control at a level lower than that when the abnormal state is grasped, for example. In contrast, when the idle period elapses without improvement of the abnormal state of the driver, the automated driving ECU 50b determines the transition to the MRM control.

The automated driving ECU 50b determines control to be performed by the automated driving function at timing when abnormality of physical condition of the driver is grasped. The automated driving ECU 50b changes contents of each of the vehicle control and the information presentation control in the idle period and after the transition to the MRM control depending on whether the abnormal state is grasped in the driving assistance control in operation or in the autonomous travel control in operation. The automated driving ECU 50b also changes the contents of each of the vehicle control and the information presentation control in the idle period and after the transition to the MRM control according to a travel control mode in operation when the abnormal state of the driver is grasped in the automated traveling period. Specifically, a length of the idle period, setting of an inter-vehicle distance in the idle period, an implementation pattern of the MRM control, and the like are changed according to control contents of the automated driving in operation.

(Change in Length of Idle Period)

The idle period when the abnormal state is grasped in the driving assistance control in operation (referred to below as a first idle period) is different from the idle period when the abnormal state is grasped in the autonomous travel control in operation (referred to below as a second idle period). The setting change section 79 sets the second idle period to be longer than the first idle period. The above setting of the idle period causes a period of issuing the improvement request notification in the idle period to be also different between when the driving assistance control is in operation and when the autonomous travel control is in operation. Specifically, the period of issuing the improvement request notification when the autonomous travel control is in operation is set longer than the period thereof when the driving assistance control is in operation.

The setting change section 79 also sets an idle period when the abnormal state is grasped at the traffic congestion level 3 in operation, the idle period being longer than an idle period when the abnormal state is grasped at the area level 3 in operation, the area level 3 being a travel control mode different from that at the traffic congestion level 3. The setting of the idle period as described above causes the period of issuing the improvement request notification to be longer when an abnormal state is grasped at the traffic congestion level 3 in operation than when the abnormal state is grasped at the area level 3 in operation.

(Setting Change of Inter-Vehicle Distance in Idle Period)

The setting change section 79 changes the setting to set the inter-vehicle distance to be wider when an abnormal state is grasped at the area level 3 in operation than when the abnormal state is grasped at the traffic congestion level 3 in operation, the traffic congestion level 3 being a travel control mode different from that at the area level 3.

(Change of Implementation Pattern of MRM Control)

When an abnormal state of the driver is grasped in the driving assistance control in operation, the MRM control section 78 selects the first evacuation control to be performed, the first evacuation control causing the subject vehicle Am to move to and stop on a road shoulder. Similarly, even when an abnormal state of the driver is grasped at the area level 3 in operation, the MRM control section 78 selects the first evacuation control to be performed, the first evacuation control causing the subject vehicle Am to move to and stop on a road shoulder. When the driving assistance control or the area level 3 is in operation, the MRM control section 78 causes the subject vehicle Am to stop on a road shoulder regardless of a position of the subject vehicle lane Lns.

Here, when the subject vehicle lane Lns is not the road shoulder side lane Ln1 in the first evacuation control, the MRM control section 78 performs a lane change for moving the subject vehicle Am to the road shoulder side lane Ln1. The lane change to the road shoulder side lane Ln1 is performed by allowing the setting change section 79 to change duration for which traveling in the same lane is continued between when an abnormal state is grasped at the area level 3 in operation and when the abnormal state is grasped in the driving assistance control in operation. Specifically, the duration of traveling in the same lane when the abnormal state is grasped at the area level 3 in operation is increased to longer than the duration of traveling in the same lane when the abnormal state is grasped in the driving assistance control in operation.

In contrast, when an abnormal state of the driver is grasped at the traffic congestion level 3 in operation, the MRM control section 78 changes contents of the MRM control according to a position of the subject vehicle lane Lns on the road (see FIGS. 6 to 8). Specifically, when an abnormal state of the driver is grasped in the subject vehicle lane Lns that is the road shoulder side lane Ln1 facing the road shoulder (see a traffic congestion scene 1 in FIG. 6), the MRM control section 78 selects the first evacuation control to be performed and causes the subject vehicle Am to stop on the road shoulder.

In contrast, when an abnormal state of the driver is grasped in the subject vehicle lane Lns that is not the road shoulder side lane Ln1, the MRM control section 78 selects the second evacuation control to be performed and causes the subject vehicle Am to stop in the subject vehicle lane Lns. That is, a scene of traveling in a traffic congestion avoids performing a lane change. Specifically, when an abnormal state of the driver is grasped in the subject vehicle lane Lns that is the passing lane Ln3 (see a traffic congestion scene 2 in FIG. 7), the MRM control section 78 causes the subject vehicle Am to move toward the center of the road (toward a median strip) and stop in the passing lane Ln3. When an abnormal state of the driver is grasped in the subject vehicle lane Lns that is the center lane Ln2 (see a traffic congestion scene 3 in FIG. 8), the MRM control section 78 causes the subject vehicle Am to move to a left or right side in the center lane Ln2 and stop in the center lane Ln2. For example, the MRM control section 78 causes the subject vehicle Am to move to and stop on a left side in a lane to allow a vehicle in the passing lane Ln3 to easily pass the subject vehicle Am.

Next, details of MRM transition processing performed by the automated driving ECU 50b to implement the transition to the MRM control described above will be described below with reference to FIG. 9 and FIGS. 1 to 3. The MRM transition processing is started based on that traveling of the subject vehicle Am becomes possible, for example, and is continued until the subject vehicle Am finishes traveling.

The MRM transition processing in S101 allows the abnormality grasping section 72 to grasp an abnormal state of physical condition caused in the driver. The abnormal state grasped in S101 is a difficult-to-drive state diagnosed by the deadman determination section 46. When it is determined in S101 that the driver has no abnormal physical condition, the abnormality grasping section 72 continues to grasp whether the driver has an abnormal state. In contrast, when it is determined that the driver has abnormal physical condition, the processing proceeds to S102.

In S102, an idle period is started. The notification request section 73 also outputs a request to issue improvement request notification to the HCU 100 in S102 based on that the idle period is started, the improvement request notification being issued using the audio device 24 and the display device.

In S103, the control switching section 77 determines whether the autonomous travel control at the level 3 is in operation. When it is determined in S103 that the autonomous travel control is in operation, the processing proceeds to S107. In contrast, when it is determined in S103 that the autonomous travel control is not in operation, the processing proceeds to S104.

In S104, the control switching section 77 determines whether start permission conditions excluding the driver condition among the plurality of the start permission conditions are satisfied. When it is determined in S104 that the start permission conditions excluding the driver condition are satisfied, the processing proceeds to S105. In S105, automated transition to the autonomous travel control is performed, and the processing proceeds to S107. Even when it is not grasped that the driver inputs the level 3 transition operation in S105, the autonomous travel control is started.

In contrast, when it is determined in S104 that the start permission conditions are not satisfied, the processing proceeds to S106. In S106, an idle period and setting of the MRM control associated with the driving assistance control are selected. When the subject vehicle Am is in a manual driving period, the driving assistance control may be automatically started in S106.

In S107, the control switching section 77 grasps a travel control mode in operation and determines whether the traffic congestion level 3 is in operation. When it is determined in S107 that the area level 3 is in operation, the processing proceeds to S108. In step S108, an idle period and setting of the MRM control, which are associated with the area level 3, are selected. In contrast, when it is determined in S107 that the traffic congestion level 3 is in operation, the processing proceeds to S109.

In S109, the lane grasping section 74 grasps a position of the subject vehicle lane Lns, and the processing proceeds to S110. In S110, an idle period and setting of the MRM control, which are associated with the traffic congestion level 3, are selected according to a position of the subject vehicle lane Lns grasped in S109. As described above, a length of an idle period, setting of an inter-vehicle distance in an idle period, an implementation pattern of the MRM control, and the like are set to contents corresponding to an automated driving level and a travel control mode in S106, S108, and S110 described above.

In S111, the abnormality grasping section 72 determines whether an abnormal state of the driver has been resolved. When it is determined in S111 that the abnormal state has been resolved, the processing returns to S101. In contrast, when it is determined in S111 that the abnormal state continues, the processing proceeds to S112.

In S112, the action determination section 63 determines whether transition timing to the MRM control arrives. When the deadman determination section 46 acquires abnormality detection information indicating determination of a difficult-to-drive state, and the idle period set in any of S106, S108, and S110 has elapsed, the action determination section 63 determines that the transition timing has arrived. When it is determined in S112 that the transition timing has not arrived, S111 and S112 are repeated.

In contrast, when it is determined in S112 that the transition timing has arrived, the processing proceeds to S113. In S113, the notification request section 73 cooperates with the HCU 100 to terminate the improvement request notification started in S102. Then, the MRM control section 78 in S114 reflects setting selected in any of S106, S108, and S110, and starts the MRM control with contents corresponding to the automated driving level and the travel control mode. As described above, the series of MRM transition processing terminates.

The first embodiment described up to here changes contents of vehicle control or information presentation control when an abnormal state is grasped in the automated traveling period, in which the subject vehicle Am travels under the autonomous travel control without obligation to monitor the surroundings, according to a travel control mode in operation. Thus, the vehicle control or the information presentation control can be adjusted to contents suitable for a situation in which the subject vehicle Am travels. As a result, anxiety of a passenger can be alleviated when a driver is brought into an abnormal state.

The control switching section 77 of the first embodiment also grasps whether the autonomous travel control at the traffic congestion level 3, which is performed only in traveling in traffic congestion, is performed as one of the travel control modes. Then, when an abnormal state of the driver is grasped, the setting change section 79 changes contents of the vehicle control or the information presentation control depending on whether the traffic congestion level 3 is in operation. As described above, the vehicle control or the information presentation control can be adjusted to contents suitable for a traffic congestion traveling scene with a low traveling speed. Thus, even when another vehicle approaches around the subject vehicle in traffic congestion, anxiety of a passenger can be alleviated.

The first embodiment allows the presentation control section 88 issues the improvement request notification when an abnormal state of the driver is grasped during the automated traveling period in which the subject vehicle Am travels under the autonomous travel control. Then, the presentation control section 88 causes the period of issuing the improvement request notification to be longer when an abnormal state is grasped at the traffic congestion level 3 in operation than when the abnormal state is grasped at the area level 3 in operation. As described above, a traffic congestion travel scene with a low traveling speed allows the subject vehicle Am to continue stable traveling even when time for improving a state of the driver is set to be long. Thus, a situation is avoided in which the MRM control is erroneously started even for the driver in normal physical condition.

The control switching section 77 of the first embodiment also grasps whether the autonomous travel control at the area level 3, which is performed only in the AD area, is performed as one of the travel control modes. The setting change section 79 changes the setting to set an inter-vehicle distance to the preceding vehicle Af to be wider when an abnormal state is grasped at the area level 3 in operation than when the abnormal state is grasped at the traffic congestion level 3 in operation. Such an increase in the distance to the preceding vehicle Af enables a sense of security of a passenger to be secured even when the subject vehicle Am travels at high speed. Additionally, the inter-vehicle distance is increased before the MRM control is started, so that automated lane change for movement to an evacuation place is likely to be smoothly performed after the MRM control is started.

The first embodiment also changes contents of corresponding one of the vehicle control and the information presentation control between when an abnormal state is grasped in the driving assistance control in operation and when the abnormal state is grasped in the autonomous travel control in operation. Thus, the vehicle control or the information presentation control can be adjusted to contents suitable for a situation in which the subject vehicle Am travels. As a result, anxiety of a passenger can be alleviated when a driver is brought into an abnormal state.

The MRM control section 78 in the first embodiment performs the MRM control to stop the subject vehicle Am at the evacuation place as the vehicle control when an abnormal state of the driver is grasped. Such automated evacuation to the evacuation place enables alleviating anxiety of the passenger even when abnormality occurs in physical condition of the driver.

The first embodiment causes the second idle period from when an abnormal state is grasped in the autonomous travel control in operation to when the automated evacuation control is started to be longer than the first idle period from when an abnormal state is grasped in the driving assistance control in operation to when the MRM control is started. When the autonomous travel control is in operation, the subject vehicle Am can continue more stable traveling than when the driving assistance control is in operation. Thus, even an idle period set long for a transition to the MRM control enables the transition to the MRM control to be stably performed.

The first embodiment allows duration of continuing traveling in the same lane under the MRM control when an abnormal state is grasped in the autonomous travel control in operation to be secured longer than when the abnormal state is grasped in the driving assistance control in operation. When the autonomous travel control is in operation as described above, the subject vehicle Am can travel more stable than when the driving assistance control is in operation. Thus, even when a long traveling duration of the same lane is secured in the MRM control, the subject vehicle Am can continue stable traveling. As a result, the movement to the evacuation place also can be smoothly performed.

The first embodiment causes setting of an inter-vehicle distance when an abnormal state is grasped to be wider than setting of an inter-vehicle distance in each of the autonomous travel control and the driving assistance control. As a result, after the abnormal state is grasped, the inter-vehicle distance to the preceding vehicle Af gradually increases. The increase in the inter-vehicle distance as described above enables alleviating anxiety of the passenger even when the driver is brought into an abnormal state.

The first embodiment also changes the contents of the MRM control when an abnormal state is grasped in the autonomous travel control at the traffic congestion level 3 in operation according to a position of the subject vehicle lane Lns on the road on which the subject vehicle is traveling. Thus, the MRM control can be adjusted to contents suitable for a surrounding situation that differs depending on the position of the subject vehicle lane Lns. As a result, anxiety of a passenger can be alleviated when a driver is brought into an abnormal state.

The first embodiment causes the MRM control for stopping the subject vehicle Am in the center lane Ln2 to be performed when an abnormal state of the driver is grasped in the subject vehicle lane Lns that is the center lane Ln2 across which other lanes exist on both sides. The traffic congestion travel scene causes the automated lane change to be difficult due to other vehicles that are densely located in each lane. In contrast, the traffic congestion travel scene enables risk of rear-end collision by the following vehicle Ab to be reduced to a low level due to low traveling speed of each of the subject vehicle Am and the following vehicle Ab. As described above, when the subject vehicle Am is traveling in the center lane Ln2, the MRM control for stopping the subject vehicle Am in the center lane Ln2 is suitable for reducing anxiety of the passenger.

The first embodiment causes the MRM control for stopping the subject vehicle Am in the center lane Ln2 to be performed by allowing the subject vehicle Am to move to and stop on a left or right side in the center lane Ln2. Such an offset stop of the subject vehicle Am allows the following vehicle Ab to easily pass the subject vehicle Am stopped. As a result, anxiety of the passenger after the stop can be alleviated. Additionally, a driver of the following vehicle Ab can easily recognize presence of the subject vehicle Am.

The first embodiment causes the MRM control for allowing the subject vehicle Am to move toward the center of a road and stop in the passing lane Ln3 to be performed when an abnormal state of the driver is grasped in the subject vehicle lane Lns that is the passing lane Ln3. Traveling in the passing lane Ln3 causes a degree of difficulty of movement to a road shoulder to increase. In contrast, the traffic congestion travel scene enables risk of rear-end collision to be reduced to a low level due to low traveling speed of each vehicle even in the passing lane Ln3. When the subject vehicle Am is moved toward the center and stopped, the following vehicle Ab easily passes the subject vehicle Am stopped. As described above, when the subject vehicle Am is traveling in the passing lane Ln3, control of moving the subject vehicle Am toward the center of the road to stop the subject vehicle Am in the passing lane Ln3 serves as the MRM control suitable for alleviating anxiety of the passenger.

The first embodiment causes the MRM control to be performed to stop the subject vehicle Am on the road shoulder of the road on which the subject vehicle is traveling regardless of a position of the subject vehicle lane Lns when an abnormal state is grasped at the area level 3 in operation. During traveling at the area level 3 allows the subject vehicle Am and surrounding vehicles to travel at relatively high speed, so that other vehicles around the subject vehicle are less likely to be in a dense state. Thus, a lane change is easily performed. In contrast, a risk of rear-end collision when the vehicle stops in the lane tends to increase. As described above, when the subject vehicle Am is traveling at the area level 3, control of moving the subject vehicle Am to the road shoulder serves as the MRM control suitable for alleviating anxiety of the passenger.

The first embodiment starts the autonomous travel control when an abnormal state of the driver is grasped even without grasping that the driver inputs the level 3 transition operation as long as the start permission conditions excluding the driver condition are satisfied. Thus, after the abnormal state occurs, traveling under the autonomous travel control can be quickly started. As a result, anxiety of a passenger can be alleviated when a driver is brought into an abnormal state.

The first embodiment includes the action determination section 63 that corresponds to a “travel control section”, the abnormality grasping section 72 that corresponds to a “physical condition abnormality grasping section”, the notification request section 73 and the setting change section 79 that correspond to a “control content change section”, and the control switching section 77 that corresponds to a “control state grasping section” and a “permission determination section”. Additionally, the MRM control section 78 corresponds to an “evacuation control section”, and the automated driving ECU 50b corresponds to a “function control device” and an “automated driving control device”.

### Second Embodiment

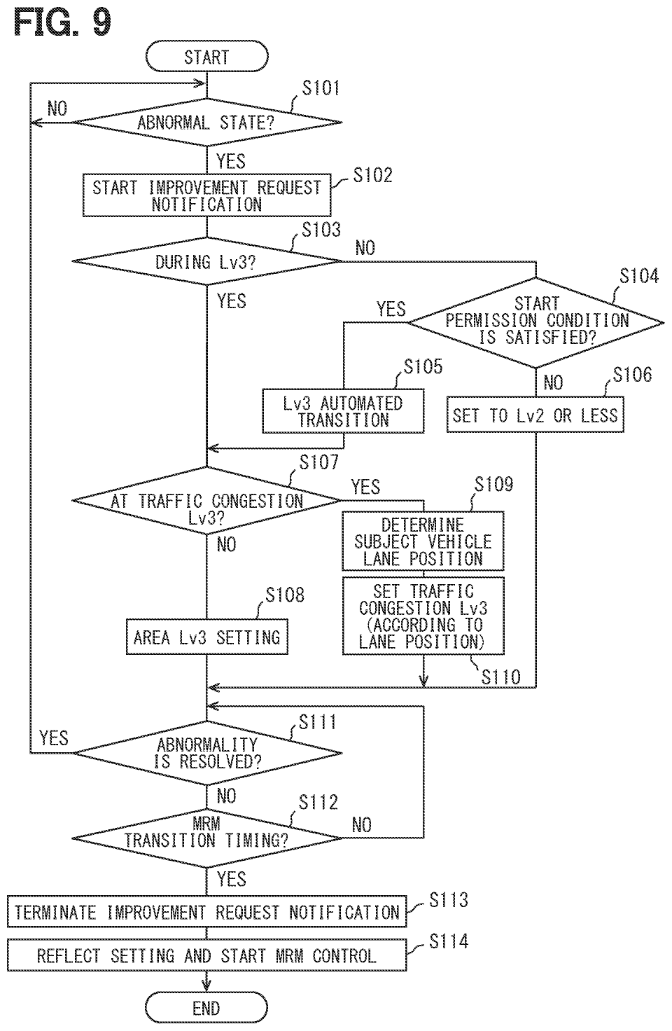

A second embodiment of the present disclosure is a modification of the first embodiment. The second embodiment eliminates the processing of changing an implementation pattern of MRM control according to a position of a subject vehicle lane Lns (see S109 and S110 in FIG. 9). As in the first embodiment, when an abnormal state is grasped in driving assistance control in operation and at an area level 3 in operation, an MRM control section 78 selects first evacuation control to be performed and moves a subject vehicle Am to a side of a road on which the subject vehicle is traveling. In contrast, when an abnormal state is grasped at a traffic congestion level 3 in operation, the MRM control section 78 selects second evacuation control to be performed and stops the subject vehicle Am in the subject vehicle lane Lns in which the subject vehicle Am is traveling regardless of a position of the subject vehicle lane Lns.

The second embodiment described up to here causes the subject vehicle Am to move to the side of the road on which the subject vehicle is traveling in the first evacuation control when an abnormal state is grasped in the driving assistance control or the like in operation, so that a risk of rear-end collision from rear can be reduced after the subject vehicle Am stops at an evacuation place. In contrast, the second evacuation control when an abnormal state is grasped at the traffic congestion level 3 in operation causes the subject vehicle Am to stop in the subject vehicle lane Lns in which the subject vehicle is traveling. When the subject vehicle is in a traffic congestion, other vehicles around the subject vehicle travel at low speed. Thus, even when the subject vehicle Am stops in the subject vehicle lane Lns, the risk of rear-end collision from rear can be reduced to a low level.

As described above, when control contents of the MRM control are changed according to a situation in which the subject vehicle Am travels, the same effects as those of the first embodiment are obtained, and thus anxiety of a passenger when a driver is brought into an abnormal state can be alleviated.

### Third Embodiment

A third embodiment of the present disclosure is another modification of the first embodiment. A driving assistance ECU 50a (see FIG. 1) of the third embodiment is capable of performing not only driving assistance control with obligation for the driver to grip the steering wheel (referred to below as a hands-on level 2), but also driving assistance control without the obligation to grip the steering wheel (referred to below as a hands-off level 2). Thus, an automated driving system 50 is capable of performing not only control transition between the hands-on level 2 and autonomous travel control, but also control transition between the hands-off level 2 and the autonomous travel control.

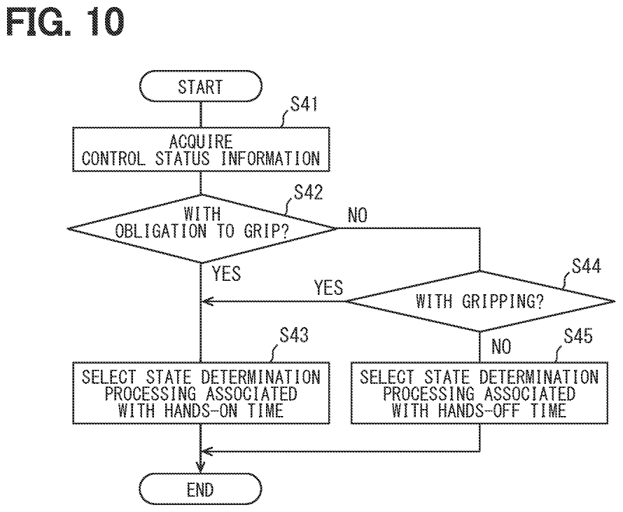

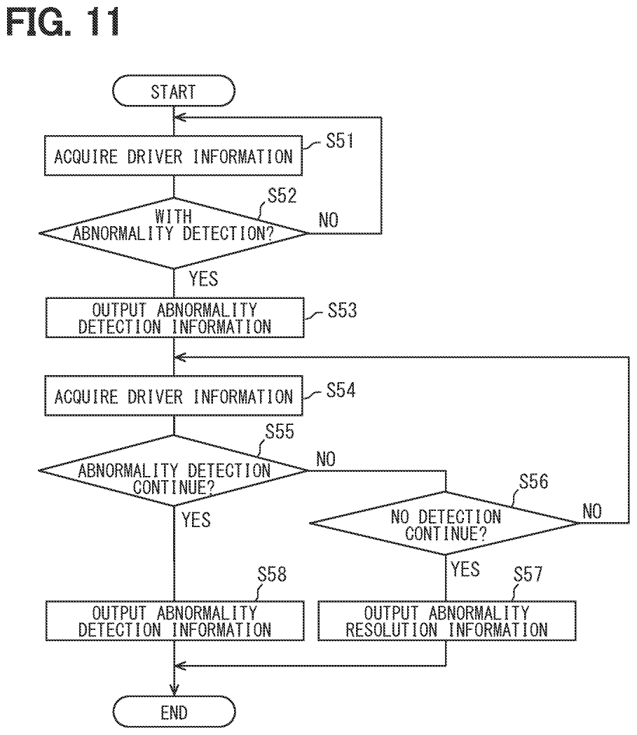

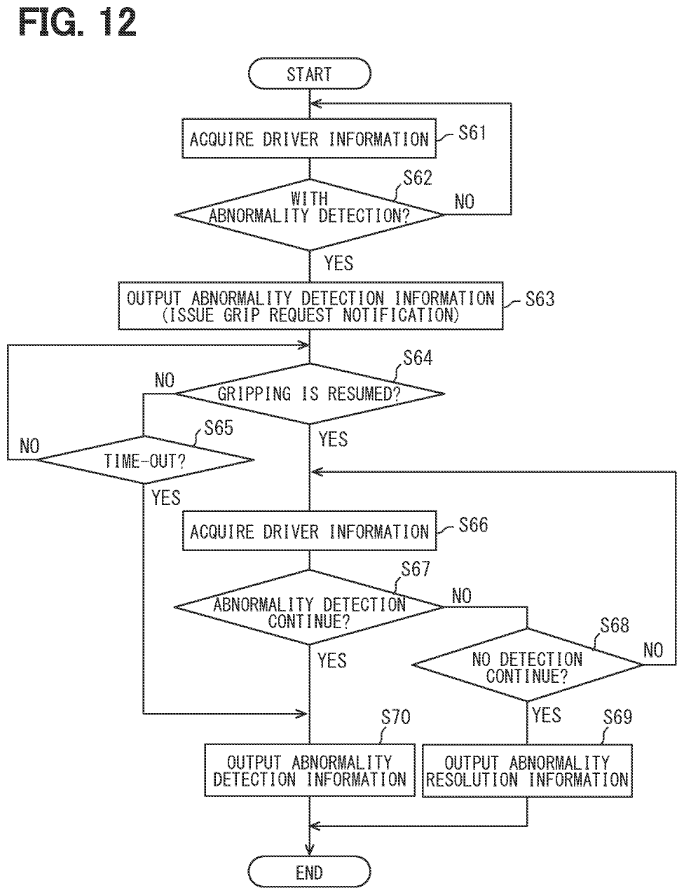

The deadman determination section 46 (see FIG. 3) changes contents of state determination processing (see FIGS. 11 and 12) for diagnosing abnormality of physical condition of the driver according to the automated driving control performed in the automated driving system 50. The deadman determination section 46 starts determination switching processing (see FIG. 10) for switching the contents of the state determination processing, together with the normal state determination processing (see FIG. 11) based on that the subject vehicle Am stats traveling, for example. The deadman determination section 46 repeatedly performs the determination switching processing and the state determination processing until a power supply of the subject vehicle Am is turned off.

(Determination Switching Processing)

The information acquisition section 47 acquires the control status information indicating a state of the automated driving function in addition to the driver status information and the steering information. The control status information may be directly acquired from the automated driving ECU 50b or may be acquired from the HCU 100. The information acquisition section 47 acquires the control status information in the determination switching processing (S41).

The abnormality detection section 48 in the determination switching processing determines whether a traveling state is with obligation for a driver to grip a steering wheel based on control steering information acquired by the information acquisition section 47 (S42). When the driving assistance control is not in operation, the abnormality detection section 48 determines that the traveling state is with the obligation for the driver to grip the steering wheel (S42: YES) when driving control at an automated driving level 1 is in operation, or when the hands-on level 2 is in operation. In this case, the abnormality detection section 48 selects the state determination processing associated with hands-on time (see FIG. 11) to be performed (S43).

In contrast, when the hands-off level 2 and the autonomous travel control are in operation in the automated driving system 50 (S42: NO), the abnormality detection section 48 determines whether the driver grips the steering wheel based on the grip detection information acquired by the information acquisition section 47 (S44). When the driver grips the steering wheel (S44: YES), the abnormality detection section 48 selects the state determination processing associated with hands-on time to be performed (S43). In contrast, when the driver does not grip the steering wheel (S44: NO), the abnormality detection section 48 selects the state determination processing associated with hands-off time (see FIG. 12) to be performed (S45).

(State Determination Processing: Hands-on Time)

The information acquisition section 47 in the state determination processing associated with hands-on time (see FIG. 11) acquires driver status information and steering information as driver information indicating a state of the driver (S51). The abnormality detection section 48 detects abnormality of the driver based on the driver information acquired by information acquisition section 47 (S52). For example, inappropriate posture of the driver, decrease in degree of wakefulness, inappropriate interruption of steering operation, and the like are each detected as the abnormality of the driver. When detecting the abnormality of the driver (S52: YES), the abnormality detection section 48 outputs abnormality detection information indicating the abnormality detection to the HCU 100 and the like (S53).

The information acquisition section 47 continues to acquire the driver information even after the abnormality of the driver is detected by the abnormality detection section 48 (S54). The abnormality detection section 48 determines whether the abnormality detection of the driver continues for a predetermined time (or a predetermined number of times) based on newly acquired driver information (S55). When it is determined that the abnormality detection of the driver continues (S55: YES), the abnormality detection section 48 outputs abnormality detection information indicating an abnormal state of physical condition of the driver to the HCU 100 and the like (S58).

When it is determined that the abnormality detection of the driver does not continue (S55: NO), the abnormality detection section 48 further determines whether a state with no abnormality detection has continued for a predetermined time or for a predetermined number of times (S56). When it is determined that the state with no abnormality detection does not continue (S56: NO), acquisition of driver information and determination of continuation of abnormality detection are repeated. In contrast, when it is determined that the state with no abnormality detection continues (S56: YES), the abnormality detection section 48 outputs abnormality resolution information indicating resolution of the abnormality to the HCU 100 and the like (S57).

(State Determination Processing: Hands-Off Time)

The information acquisition section 47 in the state determination processing associated with hands-off time (see FIG. 12) acquires driver status information as driver information indicating a state of the driver (S61). Steering information may not be acquired at the hands-off time. The abnormality detection section 48 detects abnormality of the driver based on the driver status information (S62). When the driver does not have obligation to grip the steering wheel, the steering information is excluded from the driver information used for abnormality detection. In this case, inappropriate posture and a decrease in degree of wakefulness of the driver are each detected as the abnormality of the driver, for example.

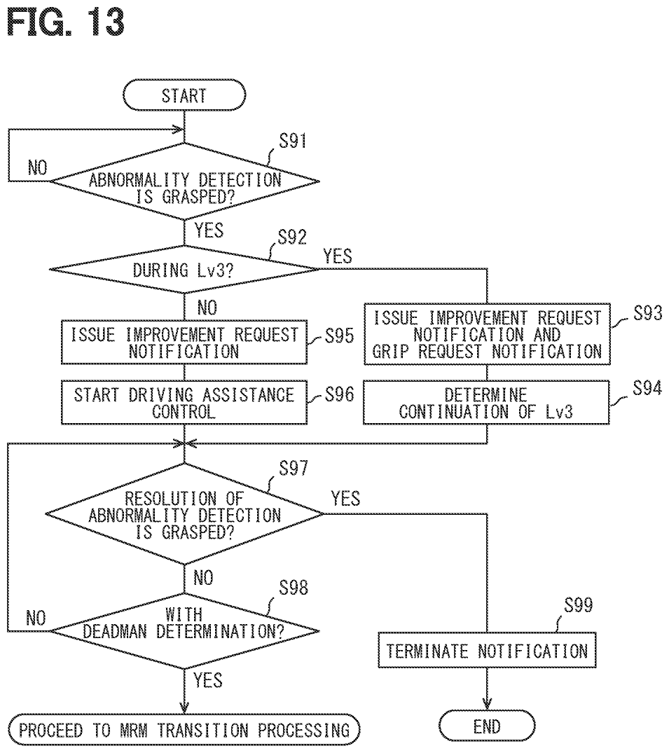

When detecting the abnormality of the driver (S62: YES), the abnormality detection section 48 outputs abnormality detection information indicating the abnormality detection to the HCU 100 and the like (S63). The HCU 100 issues grip request notification for prompting a driver to grip the steering wheel based on the abnormality detection information indicating the abnormality detection (see S93 in FIG. 13). The abnormality detection section 48 determines whether gripping of the steering wheel is resumed based on the grip detection information acquired after the grip request notification is issued (S64). When it is determined that a predetermined time has elapsed without resuming the gripping of the steering wheel (S64: NO, S65: YES), the abnormality detection section 48 determines that the physical condition of the driver is in an abnormal state (S70).

In contrast, when the gripping of the steering wheel is resumed (S64: YES), the information acquisition section 81 acquires the steering information together with the driver status information and as the driver information (S66). The abnormality detection section 48 terminates processing of removing the steering information from the driver information used for abnormality detection, and determines whether the abnormality detection of the driver continues for a predetermined time (or a predetermined number of times) based on the latest driver status information and steering information (S67). When it is determined that the abnormality detection of the driver continues (S67: YES), the abnormality detection section 48 outputs abnormality detection information indicating an abnormal state of physical condition of the driver to the HCU 100 and the like (S70).

In contrast, when it is determined that the abnormality detection of the driver does not continue (S67: NO), the abnormality detection section 48 further determines whether a state with no abnormality detection has continued for a predetermined time or for a predetermined number of times (S68) as in the processing at hands-on time. When it is determined that the state with no abnormality detection continues (S68: YES), the abnormality detection section 48 outputs abnormality resolution information indicating resolution of the abnormality to the HCU 100 and the like (S69).

Next, details of transition preparation processing performed in an idle period until the MRM control is started based on the abnormality detection information indicating the detection of the abnormality of the driver will be described below with reference to FIG. 13 and FIGS. 1 to 3. The transition preparation processing is started by the automated driving ECU 50b based on that traveling of the subject vehicle Am becomes possible, for example, and is continued until the traveling of the subject vehicle Am is terminated.

The abnormality grasping section 72 grasps that an abnormality is detected in the driver based on the driver monitoring information acquired from the HCU 100 (S91). The HCU 100 causes the information coordination section 82 to sequentially output the abnormality detection information to the abnormality grasping section 72, the abnormality detection information being acquired by the driver information grasping section 86 from the deadman determination section 46. When the abnormality grasping section 72 grasps the abnormality detection of the driver (S91: YES), the control switching section 77 grasps a control state of the automated driving system 50 and determines whether the autonomous travel control at the level 3 is in operation (S92).

When abnormality of the driver is detected during the automated driving period in which the subject vehicle Am travels under the autonomous travel control (S92: YES), grip request notification is issued in addition to the above-described improvement request notification in cooperation between the automated driving ECU 50b and the HCU 100 (S93). In this case, the notification request section 73 outputs a request to issue each notification to the HCU 100. The grip request notification causes the audio device 24 to reproduce a voice message such as “Please grip the steering wheel”, for example. The grip request notification also causes the display device to display a message image having the same content as the voice message and an icon image. Additionally, the control switching section 77 determines continuation of the autonomous travel control at the level 3 (S94) even when abnormality of the driver is detected during the automated driving period. As a result, the subject vehicle Am continues to travel without obligation for the driver to monitor the surroundings.

In contrast, when abnormality of the driver is detected during the period in which the subject vehicle Am travels under the driving assistance control or the manual driving (S92: NO), improvement request notification is issued (S95). At this time, when the driving assistance control is in operation, continuation of the driving assistance control in operation is determined. When the driving assistance control is not in operation, the driving assistance control (ACC and LTC) is automatically started (S96).

The abnormality grasping section 72 grasps whether the abnormality detection of the driver has been resolved (S97). When the abnormality grasping section 72 grasps resolution of the abnormality detection of the driver (S97: YES), the improvement request notification and the grip request notification, which are started based on the grasping of the abnormality detection, are terminated (S99). At this time, the driving assistance control, which is automatically started, may be terminated. As described above, the transition preparation processing of this time is temporarily terminated.

In contrast, when resolution of the abnormality detection of the driver is not grasped (S97: NO), the abnormality grasping section 72 grasps whether the deadman determination section 46 has determined (deadman determination) that the abnormal state of the physical condition is determined (S98). When the determination of the abnormal state is not grasped (S98: NO), the resolution of determination of the abnormality detection is continued. In contrast, when the determination of the abnormal state is grasped (S98: NO), the MRM transition processing (see FIG. 9) as in the first embodiment is started.

The third embodiment described up to here detects abnormality of the driver based on the driver information except for steering information when the subject vehicle Am travels without obligation for the driver to grip the steering wheel. Thus, the third embodiment enables avoiding a situation where abnormality is erroneously detected due to using steering information for abnormality detection even in a situation where the driver does not grip the steering wheel. As described above, anxiety of the passenger due to false detection of abnormality is less like to occur.

The third embodiment also issues grip request notification for prompting the driver to grip the steering wheel based on the abnormality detection of the abnormality detection section 48, when the subject vehicle Am is traveling without obligation to grip the steering wheel. Then, when it is checked that the steering wheel is gripped after the grip request notification is issued, the abnormality detection section 48 resumes the abnormality detection using the steering information. Thus, when the driver resumes gripping the steering wheel, the abnormality detection section 48 can determine whether the abnormality of the driver continues more accurately by using the steering information than when the steering information is not used.

The abnormality detection section 48 in the third embodiment determines that an abnormal state of physical condition has occurred in the driver when the abnormality detection continues after the abnormality detection using the steering information is resumed. Such determination of the abnormal state enables the abnormality detection section 48 to determine abnormality of physical condition even in a state where the driver leans against the steering wheel due to abnormality in physical condition, for example, because steering operation is not continuous. Thus, occurrence of serious abnormality of physical condition can be reliably detected.

The third embodiment further issues grip request notification for prompting the driver to grip the steering wheel when abnormality of the driver is detected in an automated driving period in which the subject vehicle Am travels without obligation for the driver to monitor the surroundings. Thus, when the driver is normal, the abnormality detection can be resolved. Then, even when abnormality of the driver is detected during the automated driving period, traveling in a state without the obligation to monitor the surroundings is continued. As a result, even when physical condition of the driver become abnormal, stable traveling is continued, and thus anxiety of the driver can be alleviated.

The third embodiment includes the steering wheel that corresponds to a “steering portion”, the notification request section 73 that corresponds to a “notification issuance section”, the control switching section 77 that corresponds to a “control continuation section”, and the driving assistance ECU 50a that corresponds to a “function control device”.

### OTHER EMBODIMENTS

Although the plurality of embodiments of the present disclosure have been described above, the present disclosure is not to be construed as being limited to the above-described embodiments, and can be applied to various embodiments and combinations without departing from the gist of the present disclosure.

The above embodiments each issue the improvement request notification throughout the idle period. Thus, increasing the idle period also increases a period of issuing the improvement request notification. However, the idle period and the period of issuing the improvement request notification may not coincide with each other. For example, while the period of issuing the improvement request notification has a constant length, the idle period may have a length that is changed depending on an automated driving level or a travel control mode. Alternatively, while the idle period has a constant length, the period of issuing the improvement request notification may have a length that is changed depending on the automated driving level or the travel control mode.

A first modification of the first embodiment restricts an automated transition to the level 3 when an abnormal state is grasped. For example, when the abnormal state is grasped, the automated transition to the level 3 is performed only when the driving assistance control at the level 2 is performed, specifically, ACC and LTC are both performed. In contrast, when the abnormal state is grasped under manual driving, the automated transition to the level 3 is not performed.

A second modification of the second embodiment causes the subject vehicle Am to stop in the subject vehicle lane Lns when an abnormal state of the driver is grasped while traveling in a traffic congestion under the driving assistance control, as in when an abnormal state is grasped at the traffic congestion level 3 in operation.

A third modification of the above embodiments allows the automated driving ECU 50b and the HCU 100 to cooperate to implement a function of the function control device. The third modification includes a system including the automated driving ECU 50b and the HCU 100, the system corresponding to the “function control device”. Then, a fourth modification of the above embodiments allows one in-vehicle ECU to provide a function of each of the automated driving ECU 50b and the HCU 100. The fourth modification eliminates functional sections corresponding to the information coordination sections 61 and 82.

A fifth modification of the above embodiments allows only contents of the vehicle control to be changed depending on an automated driving level or a travel control mode in the vehicle control and the information presentation control. In contrast, a sixth modification of the above embodiments allows only contents of the information presentation control to be changed depending on the automated driving level or the travel control mode in the vehicle control and the information presentation control. The sixth modification includes the HCU 100 that may correspond to the “function control device”. The HCU 100 includes the information coordination section 82 that corresponds to the “control state grasping section”, the driver information grasping section 86 that corresponds to the “physical condition abnormality grasping section”, and the presentation control section 88 that corresponds to the “control content change section”.

Then, a seventh modification of the above embodiments allows one in-vehicle ECU to provide a function of each of the automated driving ECU 50b and the HCU 100. The one in-vehicle ECU includes not only the environment recognition section 62, the action determination section 63, and the control execution section 64 of the above-described embodiments, but also functional sections corresponding to the information acquisition section 81, the driver information grasping section 86, and the presentation control section 88, the sections being constructed according to each program. The seventh modification eliminates functional sections corresponding to the information coordination sections 61 and 82. The seventh modification above includes the driver information grasping section 86 that corresponds to the “physical condition abnormality grasping section”, the presentation control section 88 that corresponds to the “notification issuance section”, and the in-vehicle ECU that corresponds to the “automated driving control device”.

Then, an eighth modification of the above embodiments allows one automated driving ECU to provide a function of each of the driving assistance ECU 50a and the automated driving ECU 50b. That is, the automated driving ECU 50b of the eighth modification is equipped with the function of the driving assistance ECU 50a. The eighth modification includes an integrated automated driving ECU that corresponds to the “function control device” and the “automated driving control device”.

The steering portion to which the driver inputs steering operation is not limited to an annular structure such as a steering wheel. The steering portion may have a lever-like or stick-like structure.

Each function provided by the automated driving ECU and the HCU in the above embodiments can be provided by software and hardware for executing the software, only software, only hardware, or a combination thereof. When such a function is provided by an electronic circuit as hardware, each function can also be provided by a digital circuit including many logic circuits or an analog circuit.

Each processor of the above-described embodiments may be individually mounted on a printed circuit board, or may be mounted on an application specific integrated circuit (ASIC), an FPGA, or the like. Additionally, a form of a storage medium (non-transitory tangible storage medium) that stores various programs and the like may also be changed as appropriate. The storage medium is not limited to a configuration provided on a circuit board, and may be provided in the form of a memory card or the like, the memory card or the like being inserted into a slot to be electrically connected to a control circuit such as an automated driving ECU or an HCU. The storage medium also may be an optical disk serving as a copy base of a program to the automated driving ECU or the HCU, a hard disk drive of the automated driving ECU or the HCU, or the like.

A vehicle equipped with the automated driving system and the HMI system is not limited to a general private car, and may be a vehicle for a rental car, a vehicle for a manned taxi, a vehicle for ride-sharing, a cargo vehicle, a bus, or the like. The vehicle equipped with the automated driving system and the HMI system may be a right-hand drive vehicle or a left-hand drive vehicle. Additionally, a traffic environment in which the vehicle travels may be a traffic environment on a premise of left-hand traffic or a traffic environment on a premise of right-hand traffic. The automated driving control and the function control related to the automated driving according to the present disclosure may be appropriately optimized according to the road traffic law of each country and region, a steering wheel position of the vehicle, and the like.

The control unit and the method thereof described in the present disclosure may be implemented by a dedicated computer constituting a processor programmed to execute one or multiple functions embodied by a computer program. Alternatively, the device and the method thereof described in the present disclosure may be implemented by a dedicated hardware logic circuit. Alternatively, the device and the method thereof described in the present disclosure may be implemented by one or more dedicated computers configured by a combination of a processor executing a computer program and one or more hardware logic circuits. The computer program may be stored in a computer-readable non-transitory tangible recording medium as an instruction to be executed by the computer.

What is claimed is:

1. A function control device that is used in a subject vehicle capable of traveling by an automated driving function and performs a control related to the automated driving function, the function control device comprising:
a physical condition abnormality grasping section that is configured to grasp an abnormal state of a physical condition caused in a driver of the subject vehicle;
a control state grasping section that is configured to grasp a travel control mode in which the automated driving function is in operation, the travel control mode being included in a plurality of traveling control modes included in autonomous travel control without obligation for the driver to monitor surroundings; and
a control content change section that is configured to change contents of at least one of vehicle control of the subject vehicle and information presentation control for the driver according to the travel control mode in which the automated driving function is in operation when the abnormal state is grasped during a period in which the subject vehicle travels under the autonomous travel control.

2. The function control device according to claim 1, wherein
the control state grasping section grasps whether a traffic congestion limited control is in operation as one of the travel control modes, the traffic congestion limited control being performed only in traveling in a traffic congestion, and
when the abnormal state is grasped, the control content change section changes contents of at least one of the vehicle control and the information presentation control according to whether the traffic congestion limited control is in operation.

3. The function control device according to claim 2, wherein
the control content change section issues improvement request notification requesting the driver to improve driver's state when the abnormal state is grasped during the period in which the subject vehicle travels under the autonomous travel control, and
the control content change section causes a period of issuing the improvement request notification to be longer when the abnormal state is grasped in the traffic congestion limited control in operation than when the abnormal state is grasped in one of the travel control modes different from the traffic congestion limited control, the one of the travel control modes being in operation.

4. The function control device according to claim 1, wherein
the control state grasping section grasps whether an area limited control is in operation as one of the travel control modes, the area limited control being performed only in a specific area, and
the control content change section changes setting to set an inter-vehicle distance to a preceding vehicle under the autonomous travel control to be wider when the abnormal state is grasped in the area limited control in operation than when the abnormal state is grasped in one of the travel control modes different from the area limited control, the one of the travel control modes being in operation.

5. A function control device that is used in a subject vehicle capable of traveling by an automated driving function and performs a control related to the automated driving function, the function control device comprising:
a physical condition abnormality grasping section that is configured to grasp an abnormal state of a physical condition caused in a driver of the subject vehicle;
a control state grasping section that is configured to grasp whether driving assistance control with obligation for the driver to monitor surroundings or autonomous travel control without obligation for the driver to monitor the surroundings is in operation in the automated driving function; and
a control content change section that is configured to change at least one of contents of vehicle control of the subject vehicle and information presentation control for the driver between when the abnormal state is grasped in the driving assistance control in operation and when the abnormal state is grasped in the autonomous travel control in operation.

6. The function control device according to claim 5, further comprising:
an evacuation control section that is configured to perform automated evacuation control for stopping the subject vehicle at an evacuation place as the vehicle control when the abnormal state is grasped.

7. The function control device according to claim 6, wherein
the control content change section causes a second idle period from when the abnormal state is grasped in the autonomous travel control in operation to when the automated evacuation control is started to be longer than a first idle period from when the abnormal state is grasped in the driving assistance control in operation to when the automated evacuation control is started.

8. The function control device according to claim 6, wherein
the control content change section allows duration of continuing traveling in a same lane under the automated evacuation control when the abnormal state is grasped in the autonomous travel control in operation to be secured longer than when the abnormal state is grasped in the driving assistance control in operation.

9. The function control device according to claim 6, wherein
the control content change section causes setting of an inter-vehicle distance to a preceding vehicle in the autonomous travel control to be wider than setting of the inter-vehicle distance in the driving assistance control, and
the control content change section causes setting of the inter-vehicle distance in the automated evacuation control to be wider than setting of the inter-vehicle distance in the autonomous travel control.

10. An automated driving control device that enables traveling of a subject vehicle by an automated driving function, the automated driving control device comprising:
a physical condition abnormality grasping section that is configured to grasp an abnormal state of physical condition caused in a driver of the subject vehicle;
a control state grasping section that is configured to grasp whether driving assistance control with obligation for the driver to monitor surroundings or autonomous travel control without obligation for the driver to monitor the surroundings is in operation in the automated driving function;
an evacuation control section that is configured to perform automated evacuation control for stopping the subject vehicle at an evacuation place when the abnormal state is grasped; and
a control content change section that is configured to cause setting of an inter-vehicle distance to a preceding vehicle in the autonomous travel control to be wider than setting of the inter-vehicle distance in the driving assistance control,
wherein
the control content change section causes setting of the inter-vehicle distance when the abnormal state is grasped to be wider than the setting of the inter-vehicle distance in the autonomous travel control before the automated evacuation control by the evacuation control section is started.

11. An automated driving control device that enables traveling of a subject vehicle by an automated driving function, the automated driving control device comprising:
a physical condition abnormality grasping section that is configured to grasp an abnormal state of physical condition caused in a driver of the subject vehicle;
a control state grasping section that is configured to grasp whether driving assistance control with obligation for the driver to monitor surroundings, or traffic congestion limited control that is autonomous travel control without obligation for the driver to monitor surroundings and is performed only in traffic congestion, is in operation in the automated driving function; and
an evacuation control section that is configured to perform first evacuation control of causing the subject vehicle to move to a side of a road on which the subject vehicle is traveling when the abnormal state is grasped in the driving assistance control in operation, and performs second evacuation control of causing the subject vehicle to stop in a subject vehicle lane in which the subject vehicle is traveling when the abnormal state is grasped in the traffic congestion limited control in operation.

12. An automated driving control device that enables traveling of a subject vehicle by an automated driving function, the automated driving control device comprising:
an input grasping section that is configured to grasp an input of operation of a driver of the subject vehicle, the input instructing a start of autonomous travel control without obligation for the driver to monitor surroundings;
a physical condition abnormality grasping section that is configured to grasp an abnormal state of physical condition of the driver; and
a permission determination section that is configured to permit a start of the autonomous travel control based on the input of operation of the driver when a plurality of start permission conditions including at least a driver condition related to a state of the driver is satisfied,
wherein
the permission determination section starts the autonomous travel control when the abnormal state is grasped even without grasping of the input of operation of the driver as long as the start permission conditions excluding the driver condition are satisfied.

13. A function control device used in a subject vehicle capable of traveling by an automated driving function, the function control device comprising:
an information acquisition section that is configured to acquire state information on a driver of the subject vehicle based on a driver image obtained by photographing the driver and steering information related to a steering operation to a steering portion performed by the driver; and
an abnormality detection section that is configured to detect an abnormality of the driver based on a plurality of pieces of driver information including at least the state information and the steering information,
wherein
the abnormality detection section removes the steering information from the driver information used for abnormality detection of the driver when the automated driving function causes the subject vehicle to travel without obligation for the driver to grip the steering portion.

14. The function control device according to claim 13, wherein
when the automated driving function causes the subject vehicle to travel without obligation to grip the steering portion, grip request notification that prompts gripping of the steering portion is issued based on the abnormality detection by the abnormality detection section, and
the abnormality detection section resumes the abnormality detection using the steering information when it is checked that the steering portion is gripped after the grip request notification is issued.

15. The function control device according to claim 14, wherein
when the abnormality detection based on the plurality of pieces of driver information continues after the abnormality detection using the steering information is resumed, the abnormality detection section determines that an abnormal state of physical condition is caused in the driver.

16. An automated driving control device that enables traveling of a subject vehicle by an automated driving function, the automated driving control device comprising:
a physical condition abnormality grasping section that is configured to grasp that an abnormality is detected in a driver of the subject vehicle;
a notification issuance section that is configured to issue grip request notification for prompting the driver to grip a steering portion when abnormality of the driver is detected in an automated driving period in which the subject vehicle travels without obligation for the driver to monitor surroundings; and
a control continuation section that is configured to continue traveling without the obligation for the driver to monitor the surroundings even when an abnormality of the driver is detected in the automated driving period.
